(19) United States
(12) Patent Application Publication
(10) Pub. No.: US 2005/0224314 A1
(43) Pub. Date: Oct. 13, 2005

(54) Coin feeding machine and gaming machine

(75) Inventors: Kazuo Okada, Koto-ku (JP); Jun Fujimoto, Koto-ku (JP); Kazuki Emori, Koto-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 11/096,185

(22) Filed: Apr. 1, 2005

(30) Foreign Application Priority Data
Apr. 2, 2004 (JP) 2004-110445
Jul. 26, 2004 (JP) 2004-217665

(51) Int. Cl. G07F 5/02; G07F 5/10; G07D 5/08

(52) U.S. Cl. 194/230

(57) ABSTRACT

A coin feeding machine and gaming machine are include a light emitting element for emitting a light and a light receiving element which is adapted to receive the light emitted from the light emitting element. It is determined that the coins do not pass across a coin passing portion when the light receiving element is synchronized with the light emitted from the light emitting element and able to demodulate the light emitted from the light emitting element, and it is determined that the coins pass across the coin passing portion when the light emitted from the light emitting element can not be demodulated by the light receiving element.

### CROSS REFERENCE TO RELATED APPLICATIONS

This invention is based upon and claims the benefit of priority under 35 U. S. C. § 119 to the prior Japanese Patent Applications No. 2004-110445, filed on Apr. 2, 2004 and No. 2004-217665, filed on Jul. 26, 2004, the entire contents of which are incorporated herein by reference.

### BACKGROUND OF THE INVENTION

1. Field of the Invention

The present invention relates to a coin feeding machine, which is operative to allow coins to be passed out one by one, and a gaming machine.

2. Description of the Related art

Attempts have heretofore been undertaken in the related art to use coins as gaming medium in various gaming machines involving slot machines. Inserting such coins into a coin insertion slot of the gaming machine allows the gaming machine to be started. Upon operation of a player to perform stop operation upon which a combination of symbols on respective reels matches a combination of predetermined symbols, a predetermined number of coins are paid out from a hopper in sequence.

A mechanism, through which the coins are paid out, is described below. In particular, this mechanism has a structure, including a coin passing portion operative to pass the coins, and a coin feeding portion operative to allow a plurality coins, received in the hopper, to be fed to the coin passing portion one by one, wherein the coin feeding portion sequentially feeds the coins to the coin passing portion in response to a command from a controller whereby the fed coins are passed out to the outside (see, for instance, Japanese Patent Application Laid-Open Publication No. 9-94319).

When the coins are fed to the coin passing portion, the coin detection sensor detects the presence of the coins delivered to the coin passing portion, upon which the controller controls the coin passing portion so as to payout the coins until the predetermined number of coins is reached in response to the detected result of the coin detection sensor. In particular, if the coin is not fed to the coin passing portion yet, the light receiving unit of the coin detection sensor remains turned on. If the coin is fed to the coin passing portion by the coin feeding portion, then, the light receiving unit of the coin detection sensor is turned off and upon further traveling of the coin through the coin passing portion, the light receiving unit of the coin detection sensor is restored to the turned-on state. With the light receiving unit of the coin detection sensor varying in modes ON-OFF-ON, the controller set forth above discriminates that a single coin is paid out, performing control to stop the coin feeding portion when the paid out coins reaches a predetermined number of coins.

However, with the structure wherein the delivery of the coin is detected when the light receiving unit of the coin detection sensor is varied from the “ON” state to the “OFF” state, if an illegal activity is conducted upon simply inserting an illegal light emitting unit (hereinafter referred to as an “illegal-light emitting unit”) to an area close proximity to the coin detection sensor, the presence of an affect resulting from the illegal-light emitting unit does not render the light receiving unit of the coin detection sensor inoperative regardless of the coin is fed to the coin passing portion, causing issues with the occurrence of the number of coins, exceeding the predetermined number of coins, delivered in excess to the coin passing portion.

Therefore, the present invention has been completed with the above issues in mind and has an object to provide a coin feeding machine and a gaming machine that are able to preclude the payout of coins in excel due to an illegal activity.

### BRIEF SUMMARY OF THE INVENTION

To achieve the above object, according to the present invention, there is provided a coin feeding machine comprising: a coin receiving portion receiving coins; a coin passing portion formed to allow the coins to pass; a coin feeding portion that feeds the coins, received in the coin receiving portion, to the coin passing portion one by one; and a coin detecting sensor detecting the coins passing across the coin passing portion, wherein the coin detecting sensor further includes a light emitting element and a light receiving element, and the light emitting element emits a light upon modulation of an optical oscillation, and wherein the coin detecting portion determines that the coins do not pass across the coin passing portion when the light receiving element is synchronized with the light emitted from the light emitting element and able to demodulate the light emitted from the light emitting element, and the coin detecting portion determines that that the coins pass across the coin passing portion when the light emitted from the light emitting element can not be demodulated by the light receiving element.

### BRIEF DESCRIPTION OF THE DRAWINGS

FIG. 1 is a perspective view showing a slot machine of a first embodiment.

FIG. 2 is a view showing an internal structure of the slot machine of the first embodiment.

FIG. 3 is a view showing a coin feeding machine of the first embodiment.

FIG. 4 is a perspective view showing a hopper of the first embodiment.

FIG. 5 is a top view showing the coin feeding machine of the first embodiment.

FIG. 6A is a perspective view of the coin feeding machine of the first embodiment.

FIG. 6B is a side view of the coin feeding machine shown in FIG. 6A as viewed from a direction VIB.

FIG. 6C is a cross-sectional view taken on line VIC-VIC of FIG. 6B.

FIG. 7 is a rear view showing the coin feeding machine of the first embodiment.

FIG. 8A is a view illustrating a connecting relationship between a peripheral structure of a coin detection sensor and an electric circuitry in the first embodiment.

FIG. 8B is a cross-sectional view taken on line VIIIB-VIIIB of FIG. 8A.

FIG. 9A is a view illustrating a connecting relationship between a peripheral structure of a coin detection sensor and an electric circuitry in a modified form.

FIG. 9B is a cross-sectional view taken on line IXB-IXB of FIG. 9A.

FIG. 10 is a view showing an internal structure of a coin detection sensor of a second embodiment.

FIG. 11 is a flowchart (No. 1) illustrating operations of a slot machine of the second embodiment.

FIG. 12 is a flowchart (No. 2) illustrating the operations of the slot machine of the second embodiment.

FIG. 13 is a flowchart (No. 3) illustrating the operations of the slot machine of the second embodiment.

FIG. 14 is a flowchart illustrating a period intervention process of a main controller of the second embodiment.

FIG. 15 is a flowchart illustrating a RESET intervention process of the coin detection sensor of the second embodiment.

FIG. 16 is a flowchart illustrating initialization process of the second embodiment.

FIG. 17 is a flowchart illustrating a period intervention process of the coin detection sensor of the second embodiment.

FIG. 18 is a view illustrating a light emitting pattern in the second embodiment.

FIG. 19 is a flowchart illustrating a port signal output process of the second embodiment.

FIG. 20 is a timing chart (No. 1) illustrating a port and an input/output of a light emitting unit and light receiving unit of the second embodiment.

FIG. 21 is a flowchart illustrating a light receiving error detection process in the second embodiment.

FIG. 22 is a timing chart (No. 2) illustrating the port and the input/output of the light emitting unit and light receiving unit of the second embodiment.

### DETAILED DESCRIPTION OF THE INVENTION

### First Embodiment

(Structures of Slot Machine and Coin Feeding Machine)

Hereinafter, a structure of a slot machine 1 of an embodiment is described with reference to the accompanying drawings.

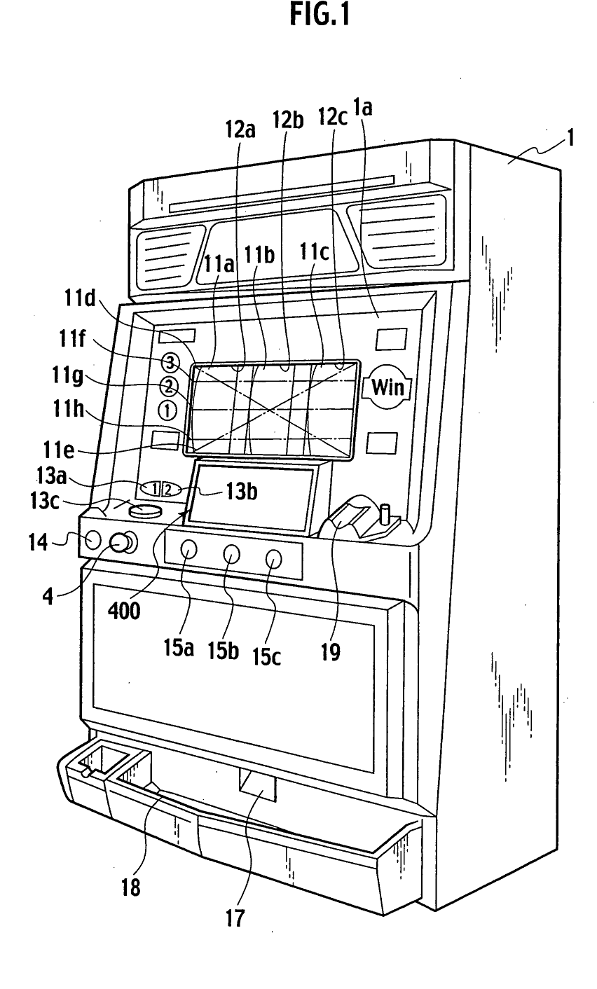

As shown in FIG. 1, three reels 11a, 11b, 11c are rotatably disposed behind a front panel of the slot machine 1. A plurality of kinds of symbols are impainted on an outer periphery of each of the reels 11a to 11c and three symbols associated with the respective reels 11a to 11c are viewed through display windows 12a, 12b, 12c, respectively. The symbols, impainted on respective reel bands located on the reels 11a to 11c, respectively, are lighted up on the display windows 12a to 12c with a lighted back lamp disposed behind the respective reels 11a to 11c. The respective reels 11a to 11c are rotated by stepping motors (not shown), thereby providing a display of the symbols, impainted on the reel bands, over the display windows 12a to 12c in varying modes. Provided on the display windows 12a, 12b, 12c are a plurality of paylines 11d, 11e and 11f, among which relevant paylines are activated when coins are inserted to a coin insertion slot 19 or BET-switches 13a to 13c are operated.

Disposed below the display windows 12a to 12c at a left side thereof is a C/P switch 14 for switching over between a credit and payout for coins. Disposed on the right side of the C/P switch 14 is a start lever 4 that starts rotates of the reels 11a to 11c, and further disposed on the right side are stop buttons 15a, 15b, 15c that stop the rotation of the respective reels 11a to 11c. Also, disposed in a front and lower area of the slot machine 1 are sound flow apertures (not shown) through which a sound, generated by a speaker, emerges, and a coin receiving portion 18 in which the coins, paid out from a coin payout opening 17, are accumulated.

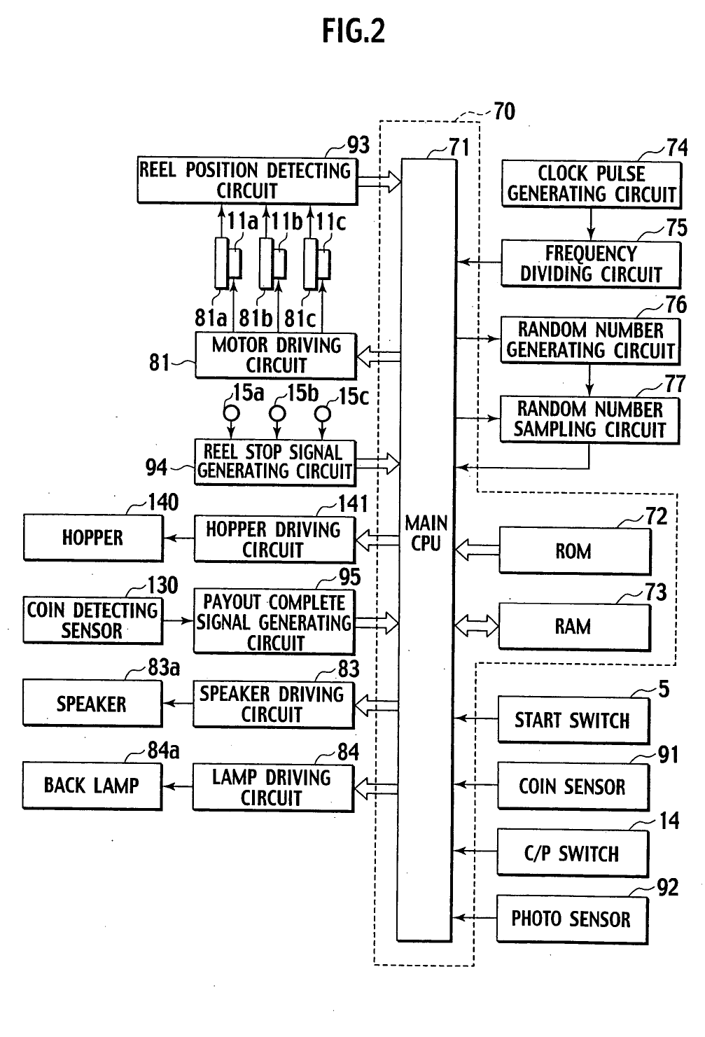

Now, a circuit structure of the slot machine 1 is described with reference to FIG. 2.

A controller 70 is mainly comprised of a microcomputer and, in addition, a circuit for sampling random numbers. The controller 70 is comprised of a CPU (main CPU) (Central Processing Unit) 71 that performs control operations in accordance with predetermined programs, an ROM (Read Only Memory) 72 and a RAM (Random Access Memory) 73.

Connected to the main CPU 71 are a clock pulse generating circuit 74, which generates reference clock pulses, and a frequency dividing circuit 75, a random number generating circuit 76 and a random number sampling circuit 77 that extracts arbitrary random numbers from the resulting random numbers. A procedure of a gaming process, to be practiced by the slot machine 1, is stored as a sequence program in the ROM 72 in which various tables are also stored. The RAM 73 is used as a temporary storage means when executing gaming operations.

Major actuators, whose operations are controlled in response to control signals from the controller 70, include the stepping motors 81a to 81c, a hopper 140 in which the coins are accumulated, a speaker 83a and a back lamp 84a, which are driven by a motor driving circuit 81, a speaker driving circuit 83, a lamp driving circuit 84 and a hopper driving circuit 141, respectively. The driving circuits 81, 83, 84, 140 are connected to the main CPU 71 via I/O ports of the microcomputer.

Main input signal generating means (input signal generating units), which generates input signals needed for the controller 70 to generate control signals, include a coin sensor 91 that detects coins inserted from the coin insertion slot 19, photo sensors 92 that detect the rotations of the reels 11a to 11c, the start switch 5 and the C/P switch 14 which are mentioned above.

Further, the input signal generating means, set forth above, include a reel position detecting circuit 93, a reel stop signal generating circuit 94 and a payout complete signal generating circuit 95. The reel position detecting circuit 93 detects rotational positions of the reels 11a to 11c in response to output pulse signals from the photo sensors 92. Also, the reel stop signal generating circuit 94 generates signals to stop the associated reels 11a to 11c when the stop buttons 15a to 15c are operated. The payout complete signal generating circuit 95 outputs a signal to the main CPU 71 so as to command completing the payout of the coins when the number of coins, paid out to the hopper 140 and counted by a coin detecting sensor 130, reaches a predetermined number of award coin data.

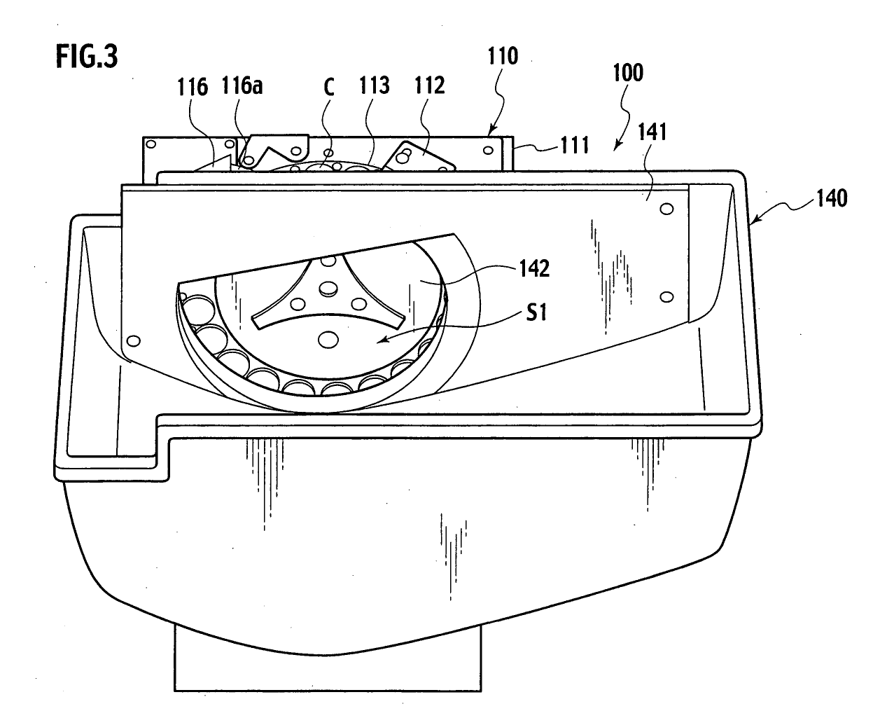

Hereunder, a coin feeding machine 100 according to the present invention is described with reference to FIG. 3.

The hopper 140, set forth above, includes a vessel in which coins (which is denoted as “C”) are received. The hopper 140 of the presently filed embodiment is formed in a configuration such that a first internal space S1 of the hopper 140 is gradually widened from a lower side (downward area in the drawing figure) toward an upper side (upward area in the drawing figure). Formed on a side surface of the hopper 140 is an opening 142 through which the first internal space S1 communicates with an external space.

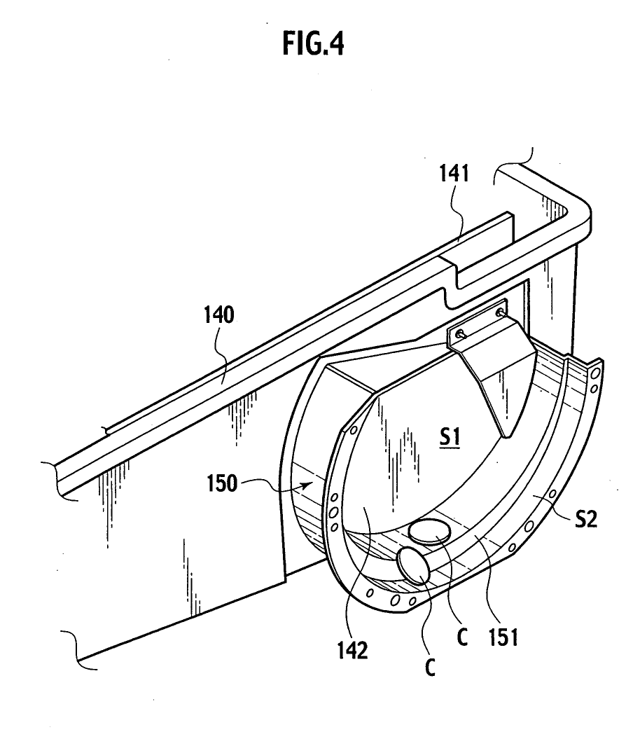

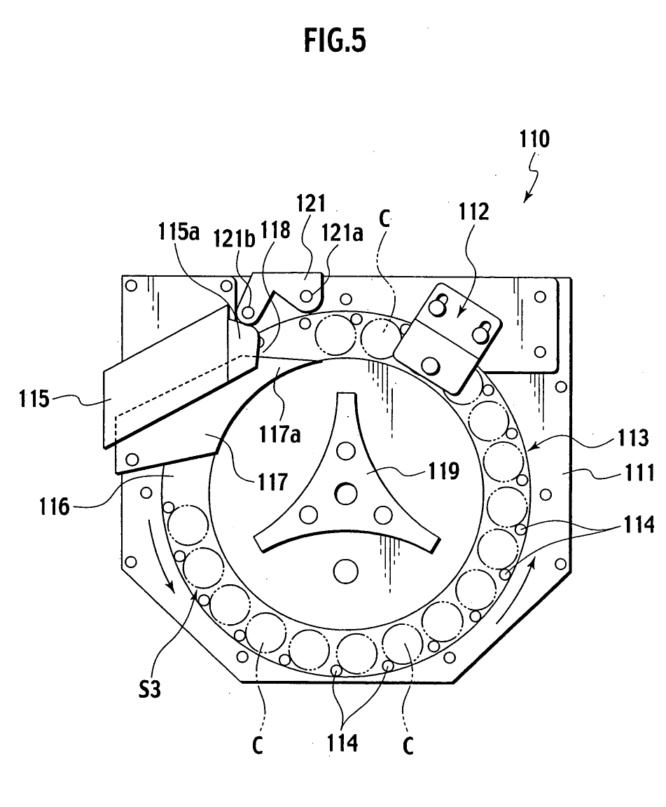

As shown in FIG. 4, the hopper 140 includes a tubular shape body 150 that protrudes toward the external space from the opening 142. The tubular shape body 150 is a tubular member that guides the coins, present in the first internal space S1 of the hopper 140, to a coin feeding portion 110 (FIGS. 3, 5). The tubular shape body 150 has one end joined to an edge of the opening 142 and the other end fixedly secured to a front side of the coin feeding portion 110 by some suitable fixing members (such as screws).

The tubular shape body 150 includes a step portion 151 formed on an internal wall close proximity to the coin feeding portion 110 in a substantially annular configuration. The step portion 151 is declined toward the coin feeding portion 110 from the hopper 140. Formed on the tabular shape body 150 is a second internal space S2 that is defined by the step portion 151 on a side near the coin feeding portion 110. As the coins, present in the first internal space S1 of the hopper 140, are induced to the step portion 151, the coins are caused to move to the second internal space S2 in a rolling motion due to declination of the step portion 151 upon which the coins stand at right angle to a surface of the first internal space S1, and the coins, which stands substantially at right angle, are received in a coindisk 113 (see FIG. 5) that will be described later.

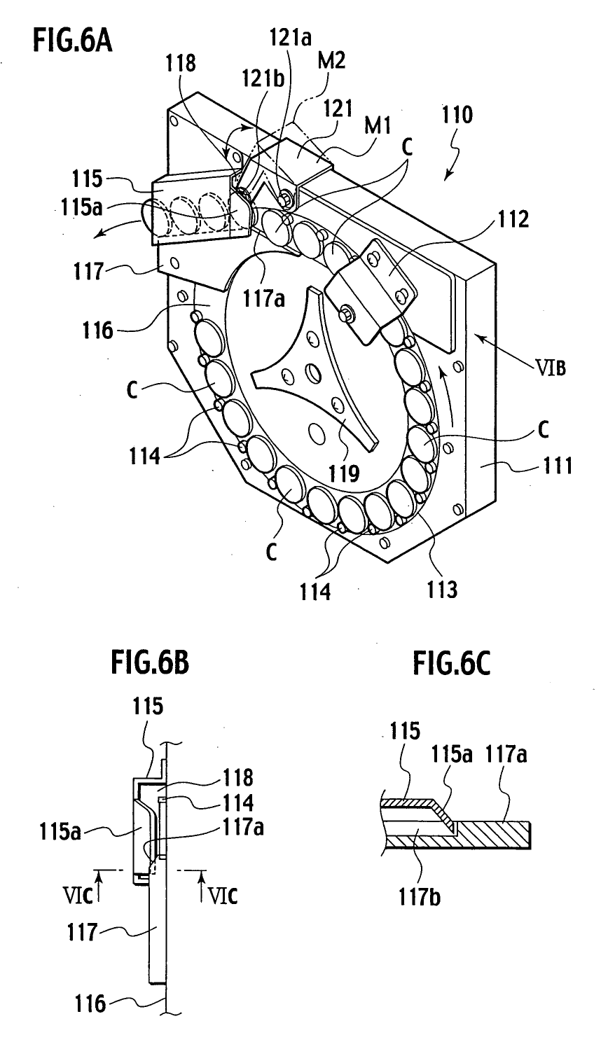

As shown in FIGS. 5 and 6A, the coin feeding portion 110 serves to feed the coins, received in the hopper 140, to a coin passing portion 115 one by one and is comprised of a coin-ripping member 112, a coin disk 113, the coin passing portion115 and a coin-leaving member 117.

A base body 111 includes a plate on which various component members of the coin feeding portion 110 are mounted. The base body 111 has a front side that is fixedly secured to one side of the tubular shape body 150 set forth above.

The coin-ripping member 112 is disposed in a path along a peripheral direction of the coin disk 113 at a position between an area in which the coins are received in the coin disk 113 and the coin passing portion 115. The coin-ripping member 112 operates in such a way that as another coin, overlapping the coin received in the coin disk 113, is transferred to the coin-ripping member 112, the overlapping coin is brought into abutment with and ripped from the coin-ripping member 112.

The coin disk 113 (so-called pinhole type coin disk) includes a plurality of pins 114, pivotally supported on the front side of the base plate 111, which protrude in a direction perpendicular to a surface 116 of the coin disk 113. The pins 114 are disposed along an outer periphery of the coin disk 113. And two of the pins define a coin receiving space S3 in to which one coin can be held.

The coin disk 113 partially intrudes into the second internal space S2 under a condition where the surface 116 of the coin disk 113 faces the first internal space S1 present in the tabular shape body 150. The coin disk 113 includes an agitating member 119 at a center thereof to agitate the coins present in an inside of the tubular shape body 150. With the agitating member 119 agitating the coins present in the inside of the tabular shape body 150, the coins are rapidly induced from the first internal space S1 to the second internal space S2 and the induced coins are immediately received in the coin receiving space S3 defined by the pins 114. Then, the coin disk 113, which is rotating counter-clockwise, allows the received coin to be transferred to the coin passing portion 115 along the peripheral direction of the coin disk 113.

The coin-leaving member 117 is a member that is mounted on the surface 116 of the coin disk 113 at an upper area thereof to cause the coin, transferred by the coin disk 113, to be left from the coin disk 113. As shown in FIG. 6A, the coin-leaving member 117 has one end 117a, to which the coin transferred by the coin disk 113 is brought into abutment, which has a shape to enable the coin to be guided to the coin passing portion 115 upon which the coin is ejected from the coin passing portion 115. The coin-leaving member 117 has a thickness nearly equal to that of the coin.

The coin passing portion 115 is a member that is formed in a shape available to pass the coin and equipped in a position close proximity to the one end 117a of the coin-leaving member 117. As shown in FIG. 6A, the coin passing portion 115 has an opening 118, formed in a side opposite to the other side on which the coin is ejected, which receives the coin rejected by the one end 117a of the coin-leaving member 117, and a coin-number restricting plate 115a, formed in a shape to partially cover the opening 118, which restricts the number of coins, to be available to be simultaneously received by the opening 118, to one coin. As shown in FIGS. 6B and 6C, the coin-number restricting plate 115a is disposed over a groove 117b formed on the one side 117a of the coin-leaving member 117. With the coin-number restricting plate 115a disposed over the groove 117b, no clearance is formed between a distal end of the con-number restricting plate 115a and the one end of the coin-leaving member 117 and no situation occurs for the coin to be caught by the restricting plate 115a.

Also, the coin passing portion 116 may be connected to a guiding member (not shown) on a side in which the coins are ejected for guiding the ejected coin to the coin payout opening 17. The coin, passing across the coin passing portion 116, is paid out from the coin payout opening 17 via the relevant guiding member.

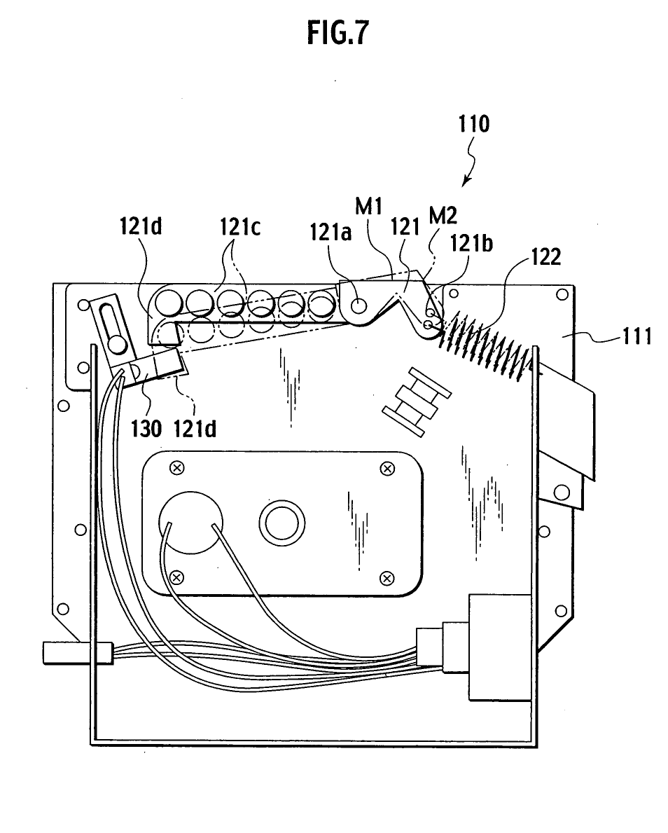

Referring to FIG. 7, the coin feeding portion 110 has a rear side provided with an arm 121 and a coin detecting sensor 130.

The arm 121 is comprised of a supporting member 121a that pivotally supports an arm 121c, which will be described later, a swinging member 121b operative to swing into or out of the opening 118 formed in the coin passing portion 116 and urged by a spring 122 for swinging capabilities so as to protrude into the opening 118 under a normal condition, and the arm 121c operative to allow the coin detecting sensor 130 to assume a non-light receiving state under a condition where the swinging member 121b is retracted from the coin passing portion 115 while rendering the coin detecting sensor 130 to assume a light receiving state under a condition where the swinging member 121b protrudes in the coin passing portion 115.

Operation of the arm 121 is described below in detail. As shown in FIGS. 6A and 7, in cases where the coin, guided to the opening 118 by the restricting plate 115a, is brought into abutment with the swinging member 121b, the relevant coin lifts up the swinging member 121b, whereby the arm 121c (and the swinging member 121b) rotates about a center of the supporting member 121a. As shown in FIG. 7, statuses before and after the arm 121c is caused to rotate about the center of the supporting member 121a are designated as M1, M2, respectively.

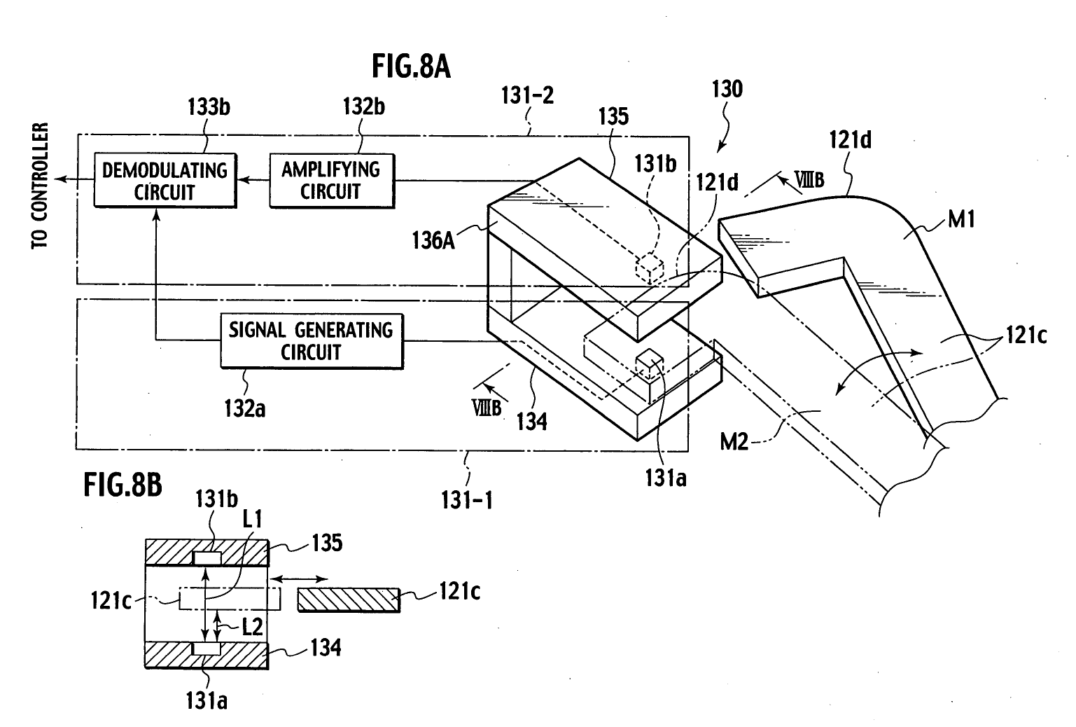

Referring to FIGS. 8A and 8B, the coin detecting sensor 130 is comprised of a light emitting unit 131-1 and a light receiving unit 131-2. As shown in FIG. 8A, the light emitting unit 131-1 includes a light emitting element 131a and a signal generating circuit 132a. Also, the light receiving unit 131-2 includes a light receiving element 131b.

Here, the arm 121c, set forth above, plays a role as a light shielding plate that under a condition where the swinging member 121b protrudes into the coin passing portion 115, the light receiving element 131b receives a light emitted from the light emitting element 131a toward the light receiving element 131b whereas under a condition where the swinging member 121b is retracted from the con passing portion 115, the light emitted from the light emitting element 131a toward the light receiving element 131b is shielded. In particular, under a normal condition where no coin is fed to the coin passing portion 115 by the coin feeding portion 110, a distal end 121d of the arm 121c is located in a position outside an area between the light emitting element 131a and the light receiving element 131b. Under such a condition, since the light emitted from the light emitting element 131a toward the light receiving element 131b is not shielded by the distal end 121d of the arm 121c (see M1 in FIG. 8A and L1 in FIG. 8B), the light receiving condition of the light receiving element 131b falls in “ON” state.

Subsequently, as the coin is transferred to the coin passing portion 115 by the coin feeding portion 115 to cause the coin to lift up the swinging member 121b, the distal end 121cd (see FIG. 7) of the arm 121c is caused to move into a space between the light emitting element 131a and the light receiving element 131b in conjunction with the swinging member 121b being lifted up. In such a case, since the light emitted from the light emitting unit 131 toward the light receiving element 131b is shielded with the distal end 121d of the arm 121c (see M2 in FIG. 8A and L1 in FIG. 8B), the light receiving condition of the light receiving element 131b falls in an “OFF” state.

Thereafter, as the coin further rolls to an outlet of the coin passing portion 115, the swinging member 121b, which has been lifted up, is restored to its original position by the elastic power of the spring 122 and the distal end 121d of the arm 121c is dislocated from the space between the light emitting element 131a and the light receiving element 131b in conjunction with restoring movement of the swinging member 121b. In such a case, since the light emitted from the light emitting unit 131 is received by the light receiving element 131b, the light receiving condition of the light receiving element 131b restores to its “ON” state.

Accordingly, although if no coin is fed to the coin passing portion 115, the light receiving condition of the light receiving element 131b remains in the “ON” state, if the coin is fed to the coin passing portion 115 swinging the swinging member 121b to travel to the outlet of the coin passing portion 115, the light receiving condition of the light receiving element 131b is temporarily turned the “OFF” state and restored to the “ON” state again. Upon operation of the controller to detect the variation in the light receiving condition, the controller discriminates that one coin has been ejected. Various component parts operate in a manner as described below.

The light emitting element 131a is located on a lower portion 134 of a member 136A, formed in a substantially C-shape configuration, in a face-to-face relationship with the light receiving element 131b to emit a light. The signal generating circuit 132a generates a light emitting signal with a wavelength of 0.72 micrometers to 1.3 micrometers and is connected to the light emitting element 131a and a demodulating circuit 133b. Also, a modulated light has a wavelength of 0.72 micrometers to 1.3 micrometers with a band different wavelength of a visible light.

The light emitting element 131a, set forth above, flashes on and off at a frequency depending on the light emitting signal based on the light emitting signal inputted from the signal generating circuit 132a. In order for the light receiving unit 131-2 to have a synchronization between a timing at which the light emitting element 131a emits a light and a timing at which the light receiving element 131b receives the light, the signal generating circuit 132a outputs a synchronizing signal to the demodulating circuit 133b on the same phase as that of the light emitting signal with the same wavelength as that of the same.

The light receiving unit 131-2 is comprised of the light emitting unit 131b, an amplifying circuit 132b and the demodulating circuit 133b. The light receiving element 131b is located on an upper portion 135 of the member 136A, formed in the substantially C-shape configuration, in a face-to-face relationship with the light emitting element 131a to accept the light emitted from the light emitting element 131a. The amplifying circuit 132b serves to amplify a light receiving signal associated with the light received by the amplifying circuit 132b and is connected to the light receiving element 131b and the demodulating circuit 133b.

Upon receipt of the light receiving signal from the amplifying circuit 132b and the synchronizing signal from the signal generating circuit 132a, the demodulating circuit 133b serves to executes the sampling of the light receiving signal at a timing at which the light emitting element 131a blinks at a frequency associated with the frequency of the synchronizing signal for thereby demodulating the light receiving signal. The demodulating circuit 133b is connected to the signal generating circuit 132a, the amplifying circuit 132b and the controller 70.

Thus, the demodulating circuit 133b detects the absence of the coin passing across the coin passing portion 115 under circumstances where the light emitted from the light emitting element 131a is synchronized and the light emitted from the light emitting element 131a can be demodulated and detects the presence of the coin passing across the coin passing portion 115 under circumstances where the light emitted from the light emitting element 131a can not be demodulated.

That is, if the amplitude of the light receiving signal is large, the arm 121c is dislocated from the area between the light emitting element 131a and the light receiving element 131b to allow the light receiving element 131b to receive the light emitted from the light emitting element 131a, whereby the demodulating circuit 133b modulates the light, synchronizing with the light emitted from the light emitting unit 131-1 and received by the light receiving element 131b for thereby detecting the absence of the coin passing across the coin passing portion 115 upon which a signal indicative of the detected result is outputted to the controller 70.

On the contrary, if the amplitude of the light receiving signal is small, the arm 121c is temporarily present in the area between the light emitting element 131a and the light receiving element 131b and the light receiving element 131b is disenabled to receive the light emitted from the light emitting element 131a, whereby no light can be demodulated and the demodulating circuit 133b detects the presence of the coin fed to the coin passing portion 115 upon which a signal indicative of the detected result is outputted to the controller 70.

Thus, according to the present invention, under circumstances where the coin passes across the coin passing portion 115 and the arm 121c is temporarily present between the light emitting element 131a and the light receiving element 131b to cause the light receiving element 131b to be unable to receive the light from a qualified light emitting unit (the light emitting element 131a), even if an illegal activity is made to insert an unqualified light emitting unit from the outside to an area close proximity to the light receiving element 131b to forcibly cause the light receiving condition of the light receiving element 131b to fall in the “ON” state to disenable the detection of the passing coin at all times, the demodulating circuit 133b is unable to demodulate the light emitted from an illegal-light emitting element and detects the presence of a normal passing of the coin, thereby precluding the coin feeding portion 100 from paying out the coin in excess caused by the illegal activity.

(Modified Form)

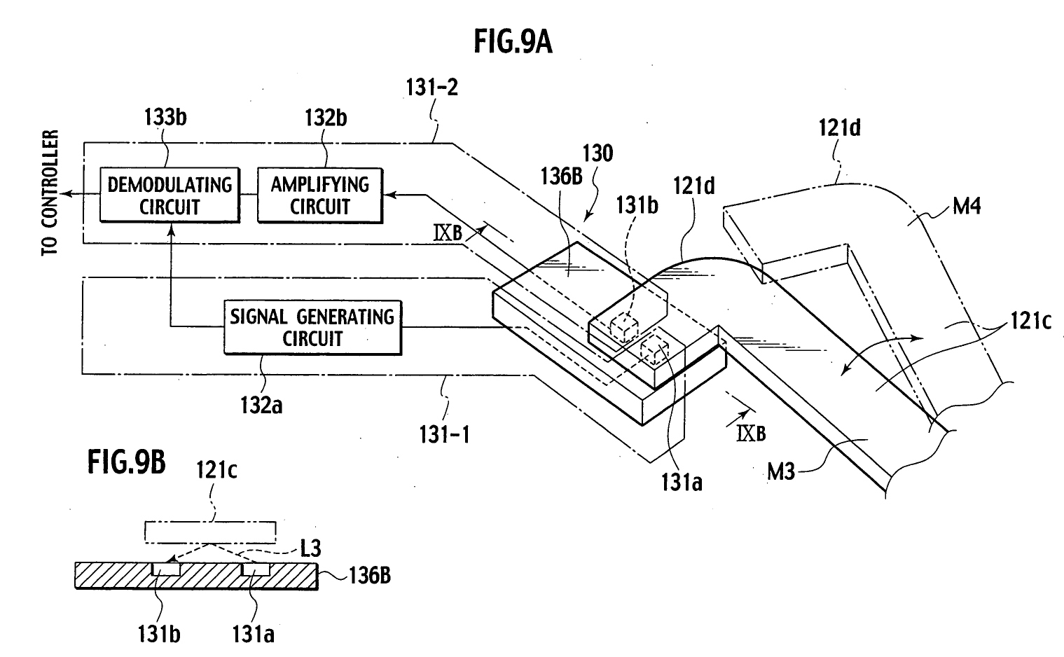

As shown in FIGS. 9A and 9B, although the light emitting unit 131-1 and light receiving unit 131-2 of the presently filed embodiment have been described as of transmissive types, the present invention is not limited to such types and may be of reflective types. As shown in FIG. 9A, the light emitting unit 131-1 and the light receiving unit 131-2 have substantially the same structure as those of the light emitting unit 131-1 and the light receiving unit 131-2 of the transmissive types but differ in structure in respect of layouts of the light emitting element 131a and the light receiving element 131b. The light emitting element 131a and the light receiving element 131b in this modified form are disposed in a bottom of a member 136B.

Here, the arm 121c includes a light reflector that allows a light, emitted from the light emitting element 131a, to be reflected to the light receiving element 131b under a condition where the swinging member 121b enters the coin passing portion 115 whereas under a condition where the swinging member 121b is retracted from the coin passing portion 115, the light, emitted from the light emitting element 131a, is not reflected to the light receiving element 131b.

The light emitting unit 131-1 and light receiving unit 131-2 operate in a manner as described below. In particular, in cases where amplitude of the accepted light signal is large, since the arm 121c is placed above the light emitting element 131a and the light receiving element 131b to allow the light receiving element 131b to receive the light emitted from the light emitting element 131a and reflected on the arm 121c (see M3 shown in FIG. 9A and L3 shown in FIG. 9B), the demodulating circuit 133b demodulates the light, which synchronizes with the light emitted from light emitting unit 131-1 and received by the light receiving unit 131-2, for thereby detecting that no coin passes across the coin passing portion 115 and outputs a signal, indicative of the resultant detection result, to the controller 70.

On the contrary, in cases where amplitude of the accepted light signal is small, since the arm 121c is not placed above the light emitting element 131a and the light receiving element 131b to disenable the light receiving element 131b to receive the light emitted from the light emitting element 131a and reflected on the arm 121c (see M4 shown in FIG. 9A), the demodulating circuit 133b is unable to demodulate the light emitted from light emitting element 131a and detects that coin passes across the coin passing portion 115 upon which a signal, indicative of the resultant detection result, is outputted to the controller 70.

Thus, with the modified form, not only the mere light shielding function (see FIGS. 9A and 9B) of the arm 121c enables the light receiving element 131b to detect the passing of the coin but also the light reflecting function of the above-described arm 121c allows the light receiving element 131b to detect the passing of the coin, whereby the coin feeding portion 100 is enabled to detect the passing of the coin in various modes.

Also, an alternative may include an error detecting unit (for instance, the demodulating circuit 133b and the controller 70) that discriminates such that under circumstances where when the light receiving element 131b received the light from the light emitting element 131a, if the received light does not synchronize with the light emitted from the light emitting element 131a, the coin payout is in an error. In such an alternative, the coin feeding portion 100 is able to take a structure that is possible to eliminate a fraudulent player who inserts an illegal-light emitting element, which is not synchronized with the light receiving element 131b, to cause the coins to be forcibly paid out.

Also, the coin feeding portion 100 may be configured such that in cases where it is discriminated by the error detecting unit that the coin payout is in error, no coin is delivered to the coin passing portion 115. In such a case, if it is discriminated by the error detecting unit that the coin payout is in error, the coin feeding portion 100 does not feed the coin to the coin passing portion 115 and the coin feeding portion 100 is able to prevent the payout of the excessive coins in an appropriate manner.

Also, the coin feeding portion 100 may include a notifying unit (for instance, the speaker 83a and the controller 70) that when the coin payout is discriminated to be in error by the error detecting unit, provides a notification of such information. In such a case, by providing the notifying unit adapted to provide information when the error detecting unit discriminates that the payout of the coins is in error, the coin feeding portion 100 is able to immediately provide a working stuff with such information indicative of the presence of the fraudulent player who causes the coins to be forcibly paid out.

Further, with the presently filed embodiment and the modified form, although the plurality of pins 114 available to receive the coins are equidistantly located in the coin feeding portion 100 along the peripheral direction thereof, the present invention is not limited to such a structure and, in an alternative, a plurality of openings (for instance, in the form of bores each formed in a concave shape) available to receive the coins may be equidistantly located in the coin feeding portion 100 along the peripheral direction thereof.

Also, while the functions (for instance, the functions of the light emitting element 131a and the light receiving element 131b) of the coin feeding portion 100 of the presently filed embodiment and the modified form are equipped in the coin feeding portion 100 per se, the present invention is not limited thereto and such functions may be provided in the sot machine 1.

Moreover, with the presently filed embodiment and the modified form, although the light receiving element 131b detects the arm 121c, the present invention is not limited thereto and the light receiving element 131b directly detects the coins.

### Second Embodiment

While with the first embodiment, demodulating process of the coin detecting sensor 130 allows the discrimination as to whether or not the coin passes across the coin passing portion 115, a second embodiment differs from the first embodiment in that discrimination is made as to whether or not the coin passes across the coin passing portion 115 based on a concept as to whether or not specified transmission data is present. With the second embodiment, the coin detecting sensor 130 is replaced with a coin detection sensor 200. Hereinafter, description is made of only such a point different from the first embodiment and duplicated description is herein omitted.

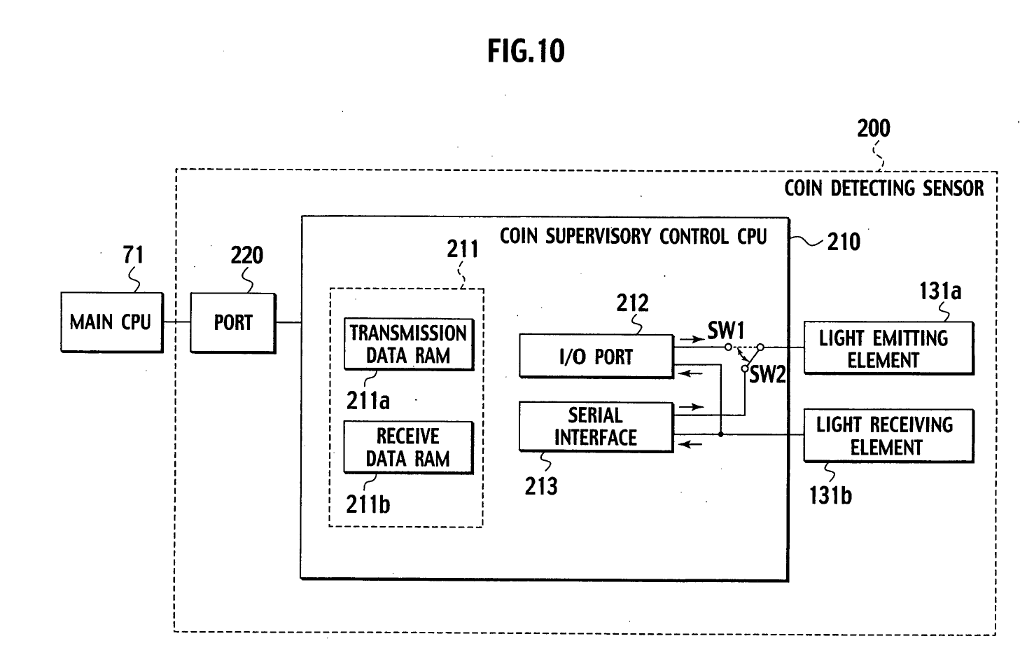

As shown in FIG. 10, the coin detection sensor 200 is comprised of the light emitting element 131a, the light receiving element 131b, a coin supervisory control CPU 210 and a port 220. Also, the light emitting element 131a and the light receiving element 131b have been already described with reference to the first embodiment and detailed description of the same is herein omitted.

The port 220 serves to output port signals from the coin supervisory control CPU 210 to a main CPU 71.

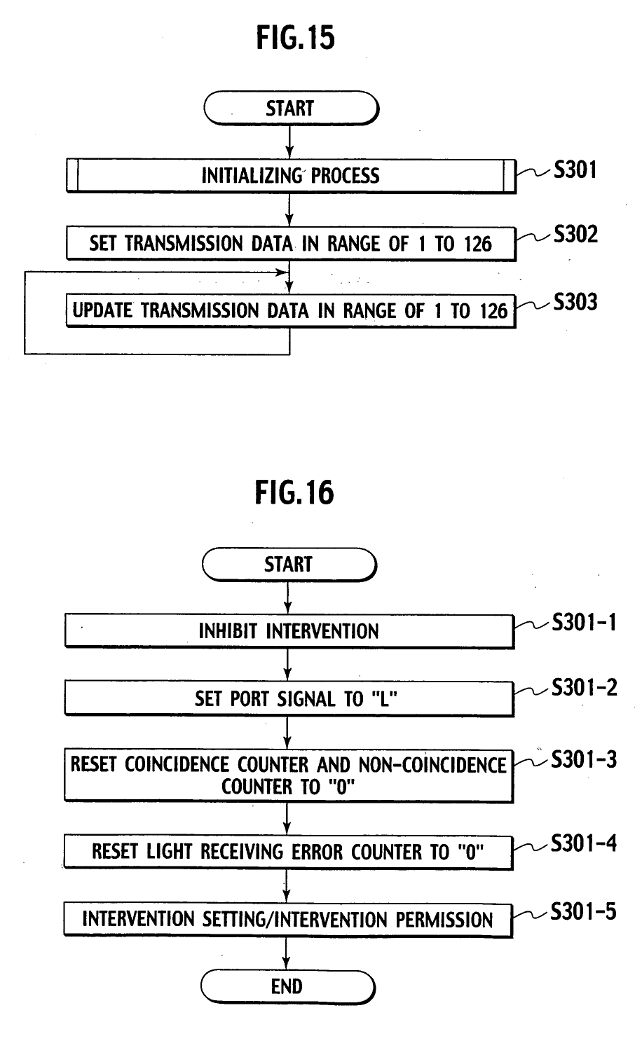

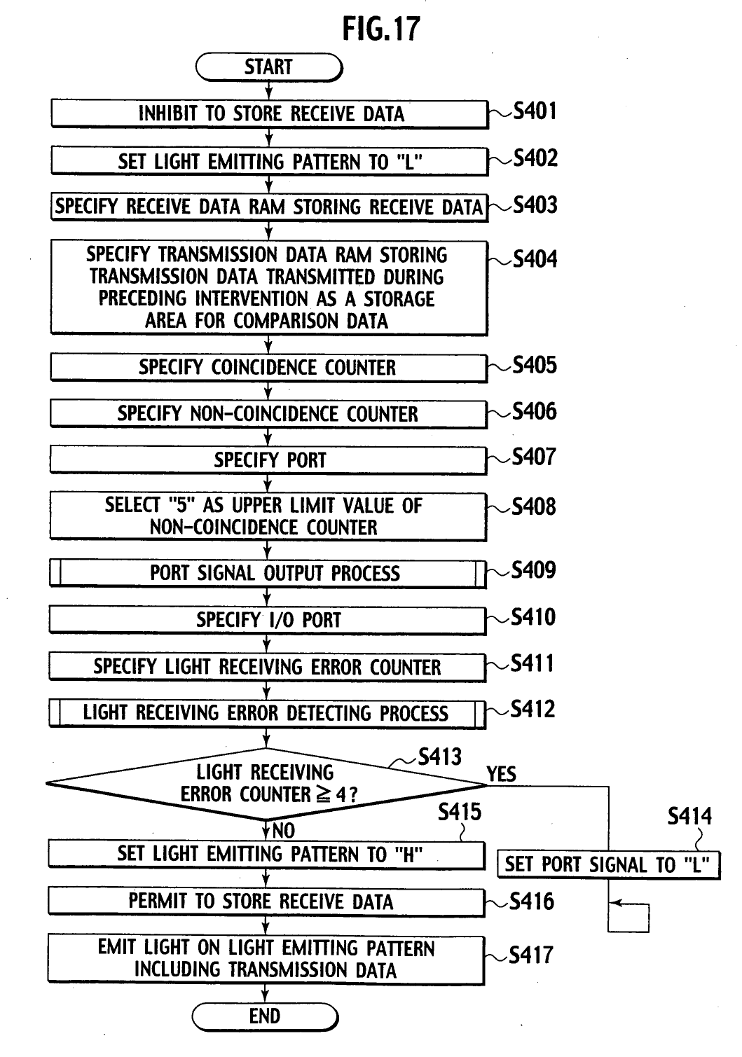

The coin supervisory control CPU 210 is comprised of a transmission data/receive data RAM 211, an I/O port (serial I/O Port) 212, and a Serial Interface 213. The coin supervisory control CPU 210 executes a RESET-intervention process shown in FIG. 15, which will be described below, and a period intervention process shown in FIG. 17. The coin supervisory control CPU 210 may be replaced with the signal generating circuit 132a, the amplifying circuit 132b and the modulating circuit 133b.

The transmission data/receive data. RAM 211 is comprised of a transmission data RAM 211a, by which transmission data is stored, and a receive data RAM 211b for storing receive data.

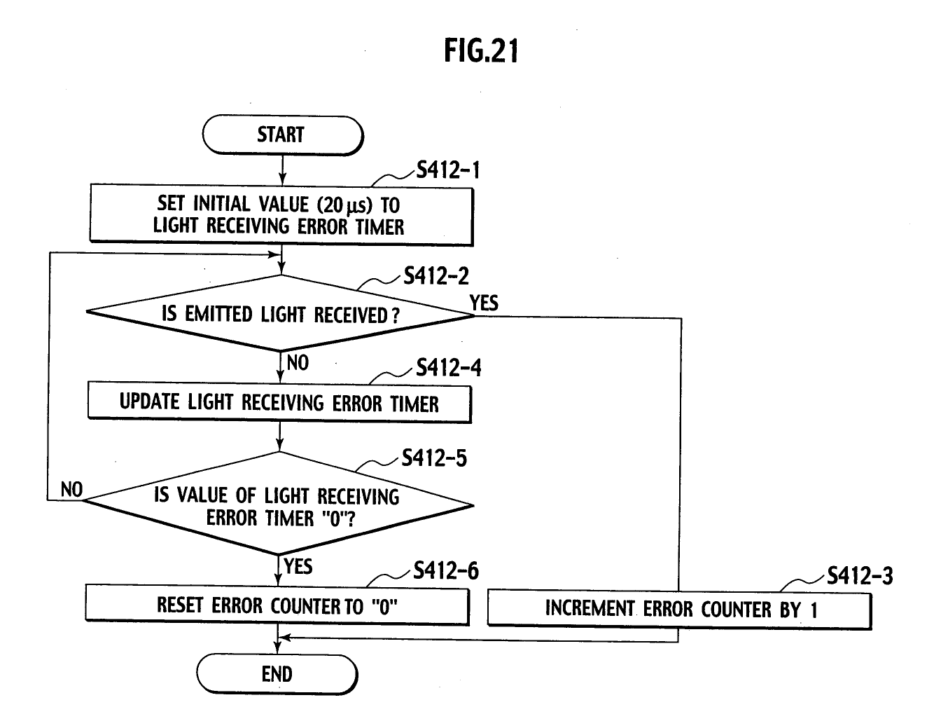

The I/O port 212 and the Serial Interface 213 relay data to be transmitted to or received from between the light emitting element 131a and the light receiving element 131b, and the transmission data/receive data RAM 211. With the light receiving error detecting process shown in FIG. 21 that will be described below, a switch is changed over to SW1 and the I/O port 212 is used.

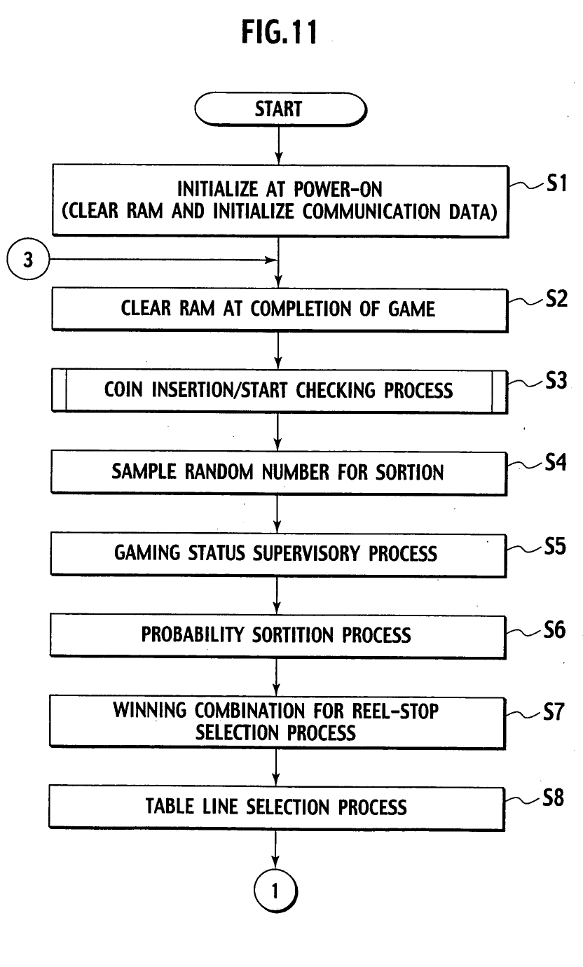

The slot machine 1 and the coin detection sensor 200 of the presently filed embodiment mentioned above operate in a manner described below. First, a basic sequence of operations to be executed by the main CPU 71 of the presently filed embodiment is described with reference to flowcharts shown in FIGS. 11 to 13.

As shown in FIG. 11, in step S1, the main CPU 71 initializes predetermined data (such as various flags, and communication data).

In step S2, the main CPU 71 clears predetermined data stored in a control RAM (not shown) when a preceding game is completed. In particular, the main CPU 71 clears parameters, used in the preceding game, from the control RAM and writes parameters, to be used in subsequent game, in the control RAM while specifying a start address of a sequence program of the subsequent game.

In step S3, the main CPU 71 executes a process to check how many number of coins are inserted or if the start lever is manipulated.

In step S4, the main CPU 71 samples a random number value for use in various decisions.

In step S5, the main CPU 71 executes a gaming status supervisory process. More particularly, the main CPU 71 discriminates that a gaming status is in a normal gaming status and under circumstances where an internal winning combination in the preceding game is involved in a “Regular Bonus” (hereinafter referred to as RB) and a winning combination in the preceding game does not belong RB, the relevant RB is set as an internal carryover combination and the gaming status is set to a Regular Bonus carryover state. In the meanwhile, under circumstances where the gaming status is discriminated to remain in the normal gaming state and the internal winning combination does not belong to RB in the preceding game whereas the internal carryover combination is set, the main CPU 71 sets the gaming status to the RB internal carryover combination, while maintaining the gaming status in the normal gaming state when the internal carryover combination is not set. Also, in cases where the gaming status is RB internal carryover combination, which is not the normal gaming state, or the RB internal carryover combination, the main CPU 71 allows the gaming status to be maintained in the RB internal carryover combination or the RB gaming status. Also, it is assumed that the RB gaming status is set in step S26 that will be described later.

In step S6, the main CPU 71 executes a probability sortition process. More particularly, the CPU 71 determines the internal winning combination based on the random number sampled in step S4 referring to a probability sortition table depending on the gaming status.

In step S7, the main CPU 71 selects a winning combination for reel-stop. More particularly, the main CPU 71 determines the winning combination for reel-stop depending on the internal winning combination and the gaming status determined in step S6 referring to a winning combination table for stop. Also, the main CPU 71 selects an activated line for juxtaposing symbol combinations associated with the determined winning combination for reel-stop.

In step S8, the main CPU 71 executes operation for selecting a stop table.

In step S9, the main CPU 71 executes operation to transmit a start command to a sub-control circuit (not shown). This start command involves the internal winning combination, the winning combination for reel-stop and the gaming status.

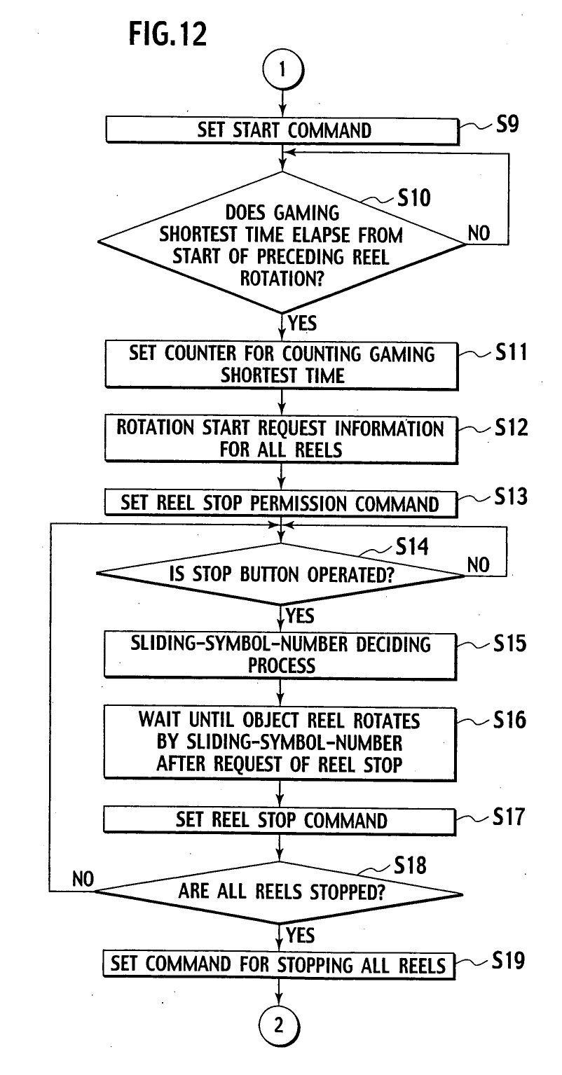

In step S10, the main CPU 71 discriminates whether or not a gaming shortest time (of, for instance, 4.1 seconds) elapses after the preceding game has been started. Also, if the gaming shortest time has elapsed, the main CPU 71 allows the operation to proceed to the operation in step S11 (see FIG. 12) and if no gaming shortest time has elapsed, the current operation is repeatedly executed.

In step S11, the main CPU 71 sets the gaming shortest time in a gaming shortest time counter. The term “gaming shortest time” means a necessary time elapsed after the preceding game is completed until a current game is commenced. Subtraction of time that is set in the gaming shortest time counter is executed in step S11 for period intervention process shown in FIG. 14.

In step S12, the main CPU 71 sets a reel start requesting information signal for commanding to commence the rotations of all the reels 11a, 11b, 11c.

In step S13, the main CPU 71 sets a reel stop signal for commanding to permit stopping the reels 11a, 11b, 11c.

In step S14, the main CPU 71 discriminates whether or not the player operates the stop buttons 15a, 15b, 15c. In particular, the main CPU 71 discriminates whether or not the input from the reel stop signal generating circuit 94 is “ON”. Further, if the input from the reel stop signal generating circuit 94 is “ON”, the operation proceeds to step S15 and if the input from the reel stop signal generating circuit 94 is “OFF”, the current operation is repeatedly executed. Meanwhile, in a case where the gaming machine does not include the stop buttons 15a, 15b, 15c, the main CPU 71 is configured to stop the reels automatically.

In step S15, the main CPU 71 executes a sliding-symbol-number deciding process for determining how much extent the symbols on the reels are moved after the stop buttons 15a, 15b, 15c are pushed by the player. More particularly, the main CPU 71 determines a number of sliding symbols based on a stop operation position and a stop control position selected in table line selecting process in step S8.

In step S16, if any of the stop buttons 15a, 15b, 15c is pushed, the main CPU 71 discriminates that there is a stop request and stands by until the reel rotates by the number of sliding symbols determined in step S15. Also, the process for rotating this reel is executed in a reel control process of the period intervention process shown in FIG. 14 that will be described later.

In step S17, the main CPU 71 sets a reel stop command for commanding to stop the rotations of the relevant reels.

In step S18, the main CPU 71 discriminates whether or not all the reels 11a, 11b, 11c are stopped. Also, if all the reels 11a, 11b, 11c are stopped, the main CPU 71 proceeds the operation to step S19 and if all the reels 11a, 11b, 11c are not stopped, the operation is proceeded to step S19.

In step S19, the main CPU 71 sets all-reel stop command indicating that all the reels 11a, 11b, 11c are stopped.

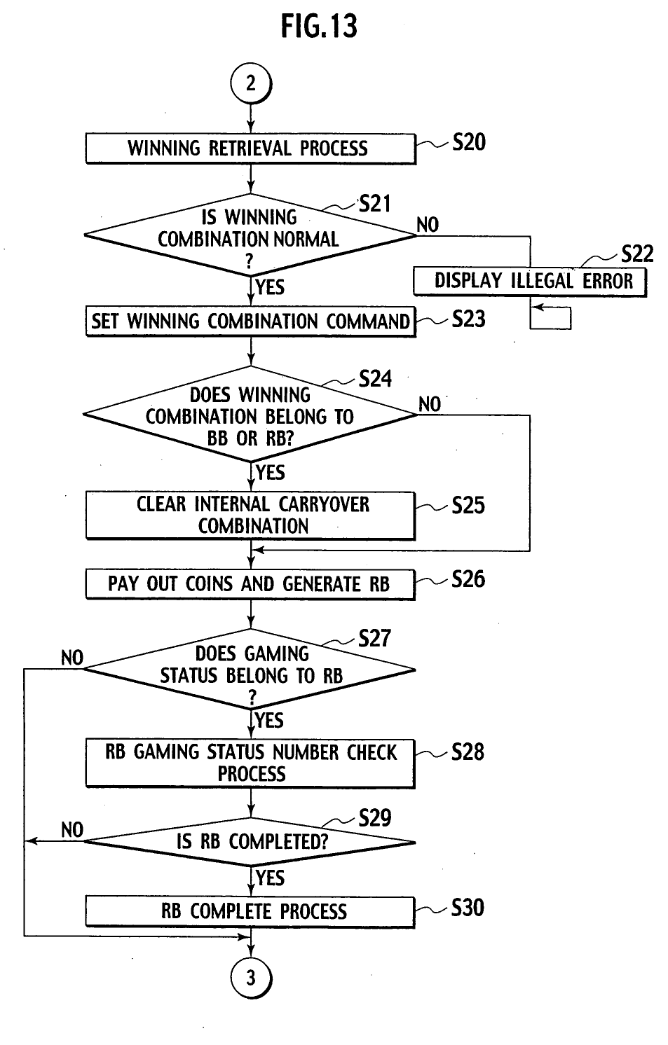

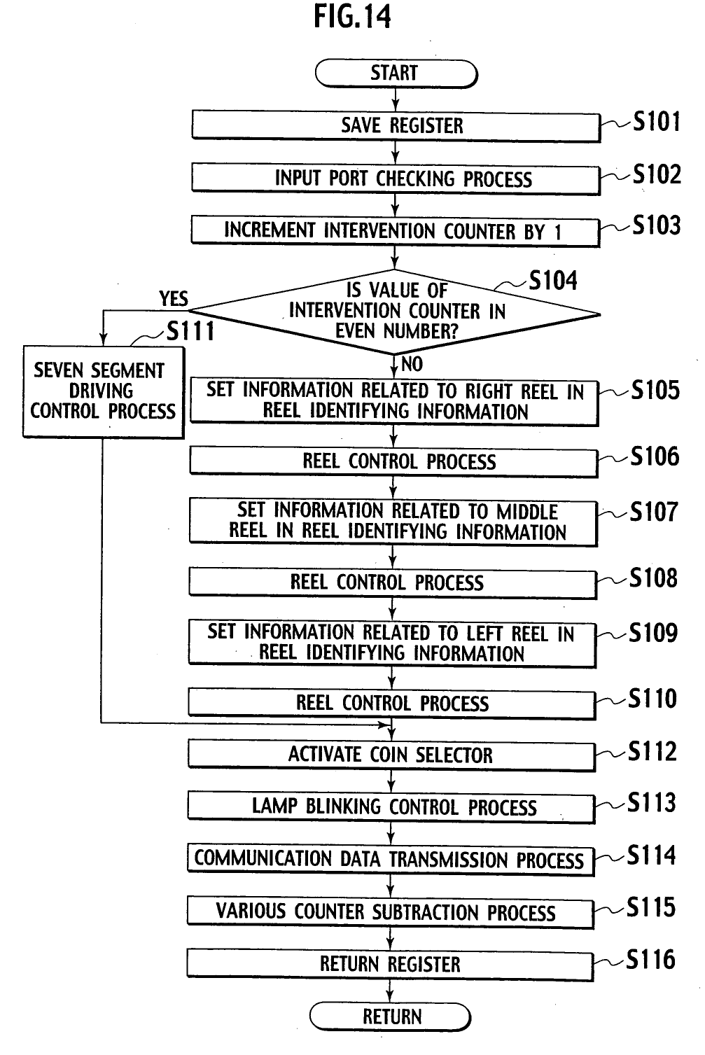

In step S20 (see FIG. 13), the main CPU 71 executes a winning retrieval. The term “winning retrieval” is to specify a winning combination based on a stop pattern of the symbols. In particular, the main CPU 71 specifies the winning combination based on a code number which is preliminary numbered to each symbol, lined up the center line (pay line 11g), and a winning determination table (not shown).

In step S21, the main CPU 71 discriminates whether or not the winning combination is normal. If the winning combination is not normal, the main CPU 71 executes the operation in step S22 and if the winning combination is normal, the main CPU 71 executes the operation in step S23. The main CPU 71 is configured to make determination whether or not the winning combination is normal such that if the winning combination is involved in the internal winning combination or the winning combination is involved in the internal carryover combination, then, the winning combination is discriminated to be normal. For instance, in cases where the winning combination belongs to a single gaming mode such as a small hit prize of a “bell” or a small hit prize of a “water melon”, if the winning combination belongs to the small hit prize of the “bell”, the small hit prize of the “water melon” or “losing”, then, the winning combination is discriminated to be normal. Also, in cases where the winning combination belongs to the small hit prize of the “bell” and the internal carryover combination corresponds to RB, if the winning combination belongs to the small hit prize of the “bell”, the small hit prize of the “water melon” or “losing”, then, the winning combination is discriminated to be normal.

In step S22, the main CPU 71 provides a display of an illegal error. Also, in such a case, the CPU 71 interrupts the game.

In step S23, the main CPU 71 sets a winning command for identifying the winning combination.

In step S24, the CPU 71 discriminates whether the winning combination belongs to the RB or BB (Big Bonus).

In step S25, the main CPU 71 clears the internal carryover combination corresponding to the RB to which the winning combination belongs.

In step S26, the main CPU provides a credit of the coins or executes the payout depending on the winning combination (such as RB) and the gaming state. Further, if the winning combination is involved in the RB, the main CPU 71 shifts the gaming state to a regular Bonus Gaming State. Furthermore, if the winning combination is involved in a replay mode, the CPU 71 stores information indicative of the winning combination being involved in the replay mode. Depending on this information, if the game is started, the main CPU 71 determines whether to allow the coins to be automatically inserted. Also, if the operation in step S3 is executed, the CPU 71 clears information indicating that the winning combination is involved in the replay mode.

In step S27, the main CPU 71 discriminates whether or not the gaming state is the RB gaming state. Further, if the gaming state is involved in the RB gaming state, the main CPU 71 executes the operation in step S28 and if the gaming state is not involved in the RB gaming state, the operation is routed back to step S2.

In step S28, the main CPU 71 executes the checking of the number of RB games. During such operation, for instance, the number of games involved in the RB gaming state and the number of winnings in the RB gaming state.

In step S29, the main CPU 71 discriminates whether or not the RB gaming state is completed. More particularly, after the RB is won upon detection of the “BAR-BAR-BAR” stopped in a display along with the activated line, the main CPU 71 discriminates whether or not the number of winning times of a JAC game in the RB gaming state is 8 times or where or not the number of game times in the RB gaming state is 12 times. Further, if the RB gaming state is completed, the main CPU 71 executes the operation in step S30 and if the RB gaming state is not completed, the operation is routed back to step S2.

In step S30, the main CPU 71 executes a completing process in the RB gaming state. In particular, the main CPU 71 executes the operation to restore the gaming state to the normal gaming state after the RB gaming state has been completed.

FIG. 14 shows the period intervention process by which intervention is executed in the main process (process shown in FIGS. 11 and 13) of the slot machine 1 for a given time interval (of 1.1725 ms). As shown in FIG. 14, in step S101, the main CPU 71 saves data stored in a register (not shown).

In step S102, the main CPU 71 checks the various input ports.

In step S103, the main CPU 71 increments a value of an intervention counter by 1. The intervention counter is a workspace for the control RAM to count the number of period intervention processes shown in FIG. 14.

In step S104, the main CPU 71 verifies whether or not the value of the intervention counter belongs to an even number. Further, if the value of the intervention counter belongs to the even number, the main CPU 71 executes the operation in step S111 and if the value of the intervention counter does not belong to the even number, the operation is executed in step S105. Here, only if discrimination is made that the result in step S104 is “NO”, the reel control operations in steps S106, S108 and S110 are executed and the reel control operation is not executed for every 1.1725 ms but executed for every 2.235 ms.

In step S105, the main CPU 71 sets information, related to the right reel 11c, in reel identifying information indicative of information, related to reels 11a, 11b, 11c, stored in the control RAM.

In step S106, the main CPU 71 executes the reel stop operation for the right reel 11c. In particular, first, when rotation start request information is set in step S12 in FIG. 12, the main CPU 71 starts rotating the right reel 11c and gradually accelerates a rotational speed of the right reel 11c until it reaches a predetermined rotational speed. If the rotational speed of the right reel 11c lies at a predetermined level and the stop button 15a is depressed, then, the main CPU 71 discriminates that there is a stop request and rotates the reel by a value corresponding to the number of sliding symbols determined in step S20, upon which the right reel 11c is stopped.

In step S107, the main CPU 71 sets information, related to the middle reel 11b, in reel identifying information.

In step S108, the main CPU 71 executes the reel stop operation for the middle reel 11b. This process is similar to that of step S106 and detailed description is herein omitted.

In step S109, the main CPU 71 sets information, related to the left reel 11a, in reel identifying information.

In step S110, the main CPU 71 executes the reel stop operation for the left reel 11a. This process is similar to that of step S106 and detailed description is herein omitted.

In step S111, the main CPU 71 executes control for displaying numeric values on the display section (not shown) composed of LEDs in seven segments.

In step S112, if the coins are inserted, the main CPU 71 activates and controls a coin selector (not shown) in a way to automatically sort normal coins from fraud coins.

In step S113, the main CPU 71 executes control for flashing the display lamps (not shown) mounted on the cabinet in front thereof.

In step S114, the main CPU 71 transmits various commands to a sub-control circuit (not shown).

In step S115, the main CPU 71 executes the operation for subtracting a predetermined number from the various counters. For instance, the main CPU 71 executes the operation to decrement the value of the game shortest time counter, set in the step S11, by a predetermined number.

In step S116, the main CPU 71 executes the operation to return the saved register.

As shown in FIG. 15, in step S301, the coin supervisory control CPU 210 executes an initialization process. Concrete operations of the initialization process are described below with reference to FIG. 16.

The coin supervisory control CPU 210 sets an arbitrary value in a range from 1 to 126 as transmission data. For instance, the coin supervisory control CPU 210 determines a value upon the execution of random number sorting operation and stores the value, determined as transmission data. As used herein, the term “transmission data” refers to is data containing a light emitting pattern for the light emitting elements 131a to be lighted. This transmission data is stored in the transmission data RAM 211a.

In step S303, the coin supervisory control CPU 210 updates the arbitrary value within the range from 1 to 126 as updated transmission data. For instance, the coin supervisory control CPU 210 determines a value (with in the range 1 to 126) upon the execution of random number sorting operation and use the value as updated transmission data (new transmission data).

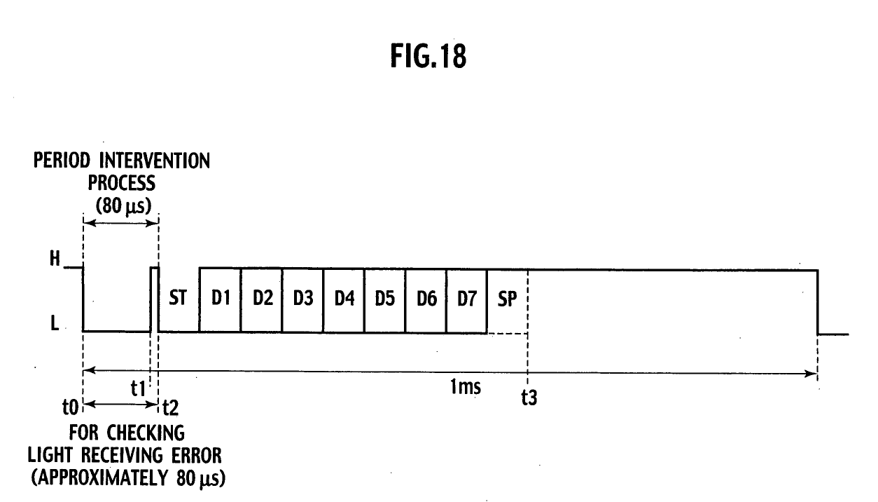

As shown in FIG. 18 that will be described below, transmission data includes 7 bits (including D1 to D7 in FIG. 18) and has combinations in 126 patterns except for all “0” and all “1”. The light emitting element 131a emits lights in light emitting patterns, including such transmission data, in step 417 (see FIG. 17) that will be described later.

FIG. 16 is shows the initialization process in step S301 described above. In step S301-1, the coin supervisory control CPU 210 executes the operation to inhibit the intervention (the generation of the period intervention process show in FIG. 17 that will be described below).

In step S301-2, the coin supervisory control CPU 210 outputs a port signal having “L-level (LOW level)” from the port 220 to the main CPU 71.

In step S301-3, the coin supervisory control CPU 210 resets a coincidence counter and a non-coincidence counter to “0”. As used herein, the term “coincidence counter” refers to a workspace in a transmission data/receive data RAM 211 that counts the number of times in which transmission data, associated with the light emitting patterns emitted by the light emitting element 131a, and receive data, associated with the light emitting patterns photo accepted by the light receiving element 131b are continuously coincident. Further, the term “non-coincidence counter” refers to a workspace in the transmission data/receive data RAM 211 that counts the number of times in which transmission data, associated with the light emitting patterns emitted by the light emitting element 131a, and receive data, associated with the light emitting patterns photo accepted by the light receiving element 131b are not continuously coincident. In step S301-4, the coin supervisory control CPU 210 resets a light receiving error counter to “0”. As used herein, the term “light receiving error counter” refers to a workspace in the transmission data/receive data RAM 211 that counts the number of times for each period intervention process wherein under situations where the light emitting element 131a is turned off (in a non-light emitting status), the light receiving unit is continuously brought into a light receiving state.

In step S301-5, the coin supervisory control CPU 210 permits the intervention (the generation of the period intervention process shown in FIG. 17 that will be described below).

The period intervention process of the presently filed embodiment is executed interrupting a RESET intervention process shown in FIG. 15, described above, for each particular period (of, for instance, 1 ms). As shown in FIG. 17, in step S401, the coin supervisory control CPU 210 inhibits received data from being newly stored in a receive data RAM 211b.

In step S402, the coin supervisory control CPU 210 renders the light emitting pattern to be set to “L” corresponding to transmission data.

FIG. 18 is a view showing the light emitting pattern involving transmission data stored in the period intervention process shown in FIG. 17. During an initial period prior to time to shown in FIG. 18, the light emitting pattern is set to a level “H” and, at a time instant at which the period intervention process takes place at time to as shown in FIG. 18, the light emitting pattern is set to the “L” level in step S402. During a period in which the light emitting patterns remain in the “L” state, if the detected result of the light receiving element 131b in the light receiving error detection process in step S412, which will be described below, is found to be “ON”, then, discrimination is made that the detected result of the light receiving element 131b is in error This enables the slot machine 1 to immediately recognize that the illegal light emitting element, inserted from the outside, is lighted up in the vicinity of the light emitting element 131a and the light receiving element 131b.

Further, as shown in FIG. 18, while transmission data, selected in the period intervention process shown in FIG. 17, is outputted in step S417, the transmission data is outputted at a time instant t2 and the digits D1 to D7, appearing between times t2 and t3, form the light emitting pattern that corresponds to transmission data. Reference ST in FIG. 18 represents a start bit and SP represents a stop bit upon which the light emitting pattern remains in a “H” state until a subsequent period intervention process occurs to commence the operation in step S402. That is, the light emitting element 131a is continuously lighted up.

In step S403, the coin supervisory control CPU 210 specifies the receive data RAM 211b in which receive data is stored. As used herein, the expression “a situation in which receive data is stored in the receive data RAM 211b” means a situation in which during a time period between time at which receive data is permitted for storage in a preceding intervention process in step S416 and time at which the storage of receive data is inhibited during current intervention in step S401, the serial interface 213 of the coin supervisory control CPU 210 stores serial data of 7 bits, received subsequent to the start bit signal, in the receive data RAM 211b based on the presence of detection of the start bit signal by means of the light receiving element 131b.

In step S404, the coin supervisory control CPU 210 specifies the transmission data RAM 211a, in which transmission data is stored in the preceding intervention process, as an area for storage of comparison data for use in step S409 that will be described below.

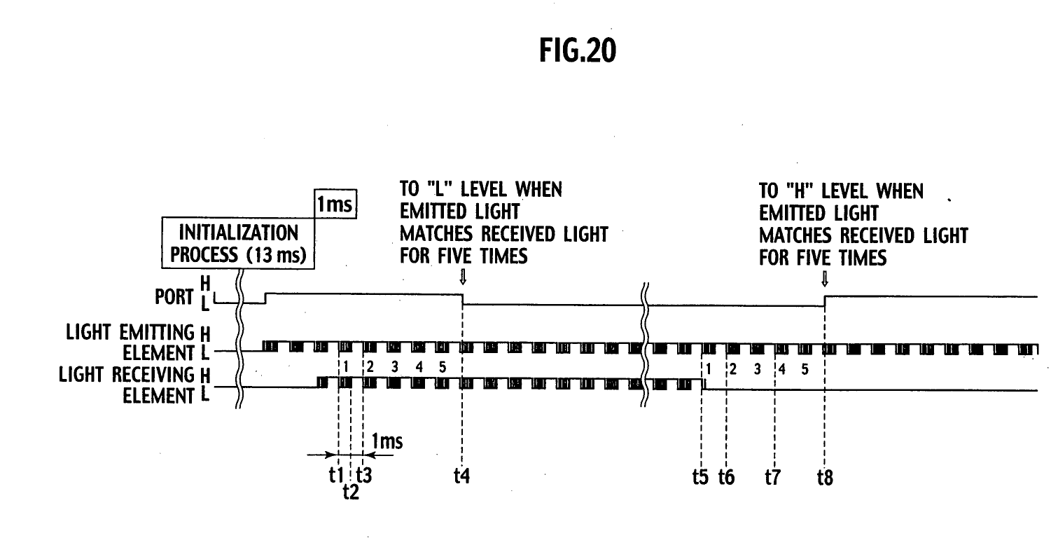

As shown in FIG. 20 that will be described later, if the current intervention occurs at time t3, transmission data, stored in transmission data RAM 211a at time t1 in the preceding intervention, becomes transmission data (comparison data). Also, as shown in FIG. 20, transmission data, stored in receive data RAM 211b at time t3 in the current intervention subsequent to the preceding intervention at time t1, becomes receive data. These transmission data and receive data are used in step S409 that will be described later.

In step S405, the coin supervisory control CPU 210 specifies the coincidence counter.

In step S406, the coin supervisory control CPU 210 specifies the non-coincidence counter.

In step S407, the coin supervisory control CPU 210 specifies the port 220 of the coin supervisory control CPU 210.

In step S408, the coin supervisory control CPU 210 selects a value of 5 as an upper limit of the non-coincidence counter.

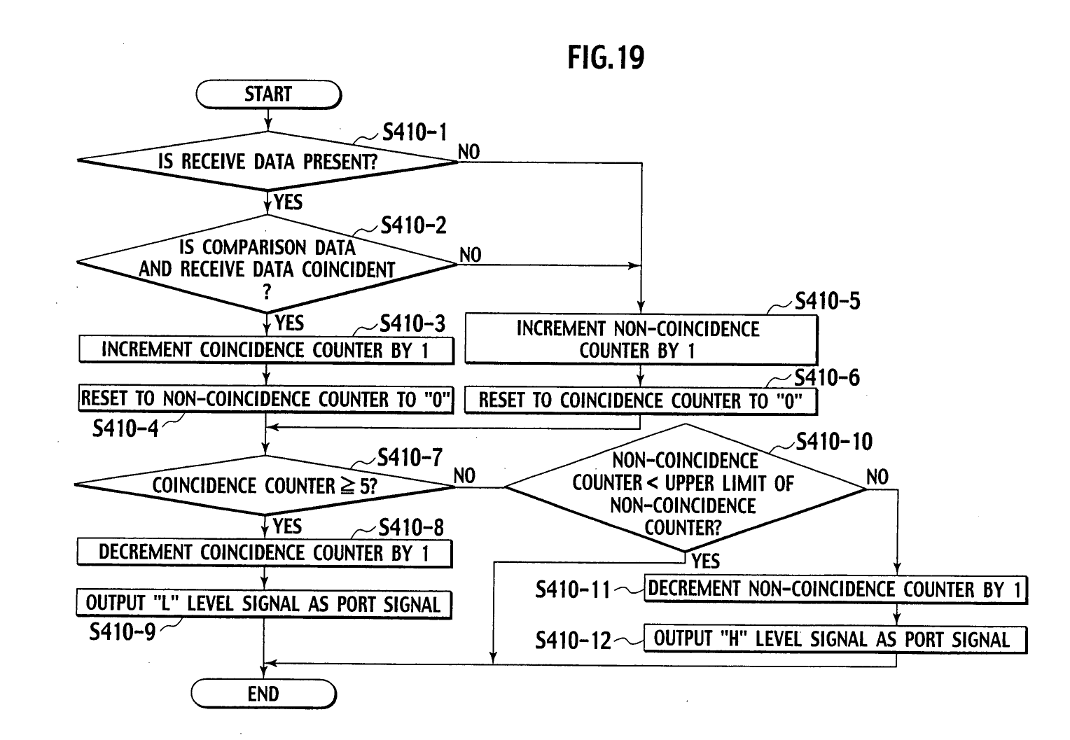

In step S409, the coin supervisory control CPU 210 executes a port signal output process. A concrete description of this port signal output process is described with reference to FIG. 19.

During a period from step S403 to step S409, the coin supervisory control CPU 210 executes the operations to output the port signal from the port 220 depending on the number of times (or the number of times in which non-coincidence continuously occurs) in which receive data, associated with the light emitting patterns photo accepted by the light receiving element 131b, and transmission data, associated with the light emitting pattern emitted by the light emitting element 131a in a preceding stage, are continuously coincident.

In step S410, the coin supervisory control CPU 210 specifies the I/O port 212. If this I/O port 212 is specified, the I/O port 212 is available to receive the emitted light signal delivered from the light receiving element 131b. In such a case, the light emitting pattern is not received as a serial signal in the manner mentioned above and a light receiving state of the light receiving element 131b, appearing when a light is inputted to the light receiving element 131b via the I/O port 212, is detected. Also, such an emitted light signal is distinguished from the light emitting pattern, set forth above, and includes a signal delivered from an illegal-light emitting element that is illegally inserted from the outside.

In step S411, the coin supervisory control CPU 210 specifies the light receiving error counter.

In step S412, the coin supervisory control CPU 210 executes a light receiving error process. The light receiving error process is described in detail with reference to FIG. 21 that will be mentioned below.

In step S413, the coin supervisory control CPU 210 verifies whether or not the light receiving error counters is greater than 4. Also, if the light receiving error counter is greater than or equal to 4, the coin supervisory control CPU 210 executes the operation in step S414 and if the light receiving error counter is not greater than 4, the coin supervisory control CPU 210 executes the operation in step S415.

In step S414, the coin supervisory control CPU 210 outputs a port signal having “L level (LOW level)” from the port 220 to the main CPU 71.

If the port signal is outputted from the port 220 to the main CPU 71, the main CPU 71 discriminates, under a condition where the inputted port signal continuously remains in the “L level” state for a predetermined time interval, that the slot machine 1 remains in an erroneous state, thereby stopping the operation of the slot machine 1. In such a case, the gaming machine outputs the port signal with the “L” state until the slot machine 1 is powered off such that no error release can be made.

In step S415, the coin supervisory control CPU 210 sets the light emitting pattern, associated with transmission data, to the “H (HIGH)” state. In particular, the coin supervisory control CPU 210 sets the light emitting pattern to lies at the “H” level at time t1 as shown in FIG. 18. Since the light emitting pattern is set to the “L” level in step S402 and the light emitting pattern is set to the “H” level in step S415, no probability occurs in fundamental practice for some light sources to be incident upon the light emitting element 131a and the light receiving element 131b. However, if an illegal activity is performed by inserting an illegal-light emitting element from the outside to an area in the vicinity of the light emitting element 131a and the light receiving element 131b to forcibly cause the arm 121c to be illegally recognized, the detected result of the light receiving element 131b varies in spite of the absence of any light source under ordinary circumstances. Therefore, upon operation of the coin supervisory control CPU 210 to monitor the detected result of the light receiving element 131b during the light receiving error detecting process in step S412, the main CPU 71 is enabled to discriminate that the illegal light emitting unit is inserted.

In step S416, the coin supervisory control CPU 210 permits receive data to be stored in the receive data RAM 211b. In particular, the coin supervisory control CPU 210 is made possible to store receive data in the receive data RAM 211b via the light receiving element 131b and the serial interface 213. In operations subsequent to such a timing, if the start bit signal (with the “L” level) is detected, the serial interface 213 stores serial data, consecutive to the start bit signal, in the receive data RAM 211b as receive data.

With the presently filed embodiment, since it takes about 80 μm for a processing time interval between step S401 and step S416, receive data begins to be stored in the receive data RAM 211b in step S416 from a time instant when a duration of about 80 μm (t2 shown in FIG. 18) has elapsed after the present period intervention process is started, and stored receive data is referred in steps S403 and S409 in subsequent interventions.

In step S417, the coin supervisory control CPU 210 allows the light emitting element 131a to emit the light based on the light emitting pattern associated with transmission data. In particular, the coin supervisory control CPU 210 shifts the switch to a position SW2 while establishing the connection between the serial interface 213 and the light emitting element 131a, upon which the light emitting element 131a is caused to emit the light based on the light emitting pattern associated with transmission data stored in the transmission data RAM 211a. Also, since step 417 of the presently filed embodiment is executed at time when the duration of about 80 μm has elapsed after the present period intervention process is started, the light emitting element 131a emits the light based on the light emitting pattern during a period in which a time interval of 1 ms, shown in FIG. 18, has elapsed from a time instant when the duration of about 80 μm has elapsed. Exemplifying the signal to be emitted in light, in particular, if a value of transmission data is updated to take a value of 100 upon the execution of step S303 immediately before the period intervention process, shown in FIG. 17, is started, the period intervention process in FIG. 17 allows a value of 100 to be stored in the transmission data RAM 211a. Since this value in represented as “110 0100” in terms of binary 7 bits, in effect, the light emitting element 131a outputs signals “L”, “L”, “H”, “H”, “L”, “H”, “H” as the signals D1 to D7 based on the value of the transmission data RAM 211a after the start bit signal with the low level “L”, as shown in FIG. 18, while outputting the stop bit signal with the high level “H”. That is, the light emitting element 131a takes lighting modes such as lighted out (start bit), lighted out (D1), lighted out (D2), lighted up (D3), lighted up (D4), lighted out (D5), lighted up (D6), lighted up (D7).

FIG. 19 is a view showing the port signal output process in step S409 as set forth above. As shown in FIG. 19, in step S410-1, the coin supervisory control CPU 210 verifies whether or not receive data is stored. If a current period intervention process occurs at time t3 as shown in FIG. 20 that will be described later, in particular, the coin supervisory control CPU 210 verifies whether or not receive data, associated with the light emitting pattern in which the light is emitted during a period from time t1 to time t3 at the instant of the occurrence of the preceding period intervention process, is stored. Also, if receive data is stored, the coin supervisory control CPU 210 executes the operation in step S410-2 and if receive data is not stored, the coin supervisory control CPU 210 executes the operation in step S410-5.

In step S410-2, the coin supervisory control CPU 210 verifies whether or not transmission data (comparison data), stored in the preceding intervention (here, at time t1), and receive data, verified in step S410-1, are coincident to each other. Moreover, if transmission data, stored in the preceding intervention, and receive data, verified in step S410-1, are coincident, the coin supervisory control CPU 210 executes the operation in step S410-3. In contrast, if transmission data, stored in the preceding intervention, and receive data, verified in step S410-1, are not coincident to each other, the coin supervisory control CPU 210 executes the operation in step S410-5.

In step S410-3, the coin supervisory control CPU 210 increments the value of the coincidence counter by 1.

In step S410-4, the coin supervisory control CPU 210 resets the non-coincidence counter to “0”.

In step S410-5, the coin supervisory control CPU 210 increments the non-coincidence counter by 1.

In step S410-6, the coin supervisory control CPU 210 resets the coincidence counter to “0”.

In step S410-7, the coin supervisory control CPU 210 verifies whether or not a value of the coincidence counter exceeds a specified value (of 5). Also, if the value of the coincidence counter exceeds the specified value (of 5), the coin supervisory control CPU 210 executes the operation in step S410-8 and if the value of the coincidence counter does not exceed the specified value (here, 5), the operation is executed in step S410-10.

In step S410-8, the coin supervisory control CPU 210 decrements the value of the coincidence counter by 1. Since this precludes the value of the coincidence counter to exceed a specified value (of 6) in excess of +1, the coin supervisory control CPU 210 is able to preclude a burden from being placed on a storage capacity of the transmission data/receive data RAM 211.

In step S410-9, the coin supervisory control CPU 210 outputs a port signal having “L level (LOW level)” from the port 220 to the main CPU 71.

In step S410-10, the coin supervisory control CPU 210 verifies whether or not the value of the non-coincidence counter is less than the upper limit value of the non-coincidence counter selected in step S408. Further, if the value of the non-coincidence counter is less than the upper limit value of the non-coincidence counter selected in step S408, the coin supervisory control CPU 210 terminates the present port signal output process and if the value of the non-coincidence counter is not less than the upper limit value selected in step S408, the operation is executed in step S410-11.

By switching the level of the port signal to the “L” or “H” states under conditions where the value of the coincidence counter or the non-coincidence counter lie at a predetermined value, there is a probability for the coin supervisory control CPU 210 to be enabled not to switch the port signal to the “L” or “H” states in response to a noise signal applied from the outside, and the main CPU 71 is able to determine a passing state of the coin in a further accurate fashion.

In step S410-11, the coin supervisory control CPU 210 decrements the non-coincidence counter by 1. Since this precludes the value of the non-coincidence counter from exceeding the upper limit value, the coin supervisory control CPU 210 is able to preclude a burden from being placed on the storage capacity of the transmission data/receive data RAM 211.

In step S410-12, the coin supervisory control CPU 210 outputs the port signal with the “H” level to the main CPU 71.

FIG. 20 is a timing chart showing the relationship between the port signal, outputted from the port 220, and the detected results of the light receiving element 131b. As shown in FIG. 20, if current intervention occurs at time t3, since transmission data, stored during the period from time t2 at which the preceding intervention occurs to time t3 at which the current intervention occurs, and receive data match each other, the coin supervisory control CPU 210 increments the value of the coincidence counter by 1. Then, the coin supervisory control CPU 210 verifies whether or not transmission data, stored in the preceding intervention, and receive data match each other even in subsequent intervention and if both are coincident, the value of the coincidence counter is incremented by 1 again.

That is, the coin supervisory control CPU 210 executes the similar processes for predetermined number of times (here, five times) for each of the occurrences of the period intervention process shown in FIG. 17 upon which under circumstances where transmission data, stored in the preceding period intervention process, and receive data are consecutively coincident for the predetermined number of times, it is discriminated that the arm 121c remains within a range detectable by the light emitting element 131a and light receiving element 131b. In this moment, the coin supervisory control CPU 210 sets the port signal, to be outputted from the step S410-9, in the “L” level (see time t4 shown in FIG. 20).

On the other hand, when the current intervention occurs at time t6, since-transmission data, stored during a period from time t5 at which the preceding intervention occurs to time t6 at which the current intervention occurs, and receive data is not coincident, the coin supervisory control CPU 210 increments the value of the non-coincidence counter by 1. That is, the coin supervisory control CPU 210 executes the similar processes for predetermined number of times for each occurrence of the period intervention process shown in FIG. 17 and if transmission data, stored in the preceding period intervention process, and receive data are not coincident for the predetermined number of times, it is discriminated that the arm 121c is out of the range detectable by the light emitting element 131a and light receiving element 131b. In this moment, the coin supervisory control CPU 210 sets the port signal, to be outputted from the step S410-12, in the “H” level (see time t8 shown in FIG. 20).

Under situations where the level of the port signal, inputted from the port 220, varies as expressed as HAL-H, then, the main CPU 71 detects the presence of the coins being passed.

FIG. 21 is a view showing the light receiving error detection process in step S412 set forth above. As shown in FIG. 21, in step S412-1, the coin supervisory control CPU 210 sets an initial value (of, for instance, a value corresponding to 20 μm) to a light receiving error timer.

In step S412-2, the coin supervisory control CPU 210 verifies whether or not the emitted light signal is photo accepted via the I/O port specified in step S410. Moreover, if the emitted light signal is photo accepted, the coin supervisory control CPU 210 executes the operation in step S412-3 and if the emitted light signal is not photo accepted, the coin supervisory control CPU 210 executes the operation in step S412-4. Also, as set forth above, the emitted light signal is distinguished from the light emitting pattern and may include those such as a light, different from the light emitted from the light emitting element 131a, but emitted from the light emitting unit illegally inserted from the outside.

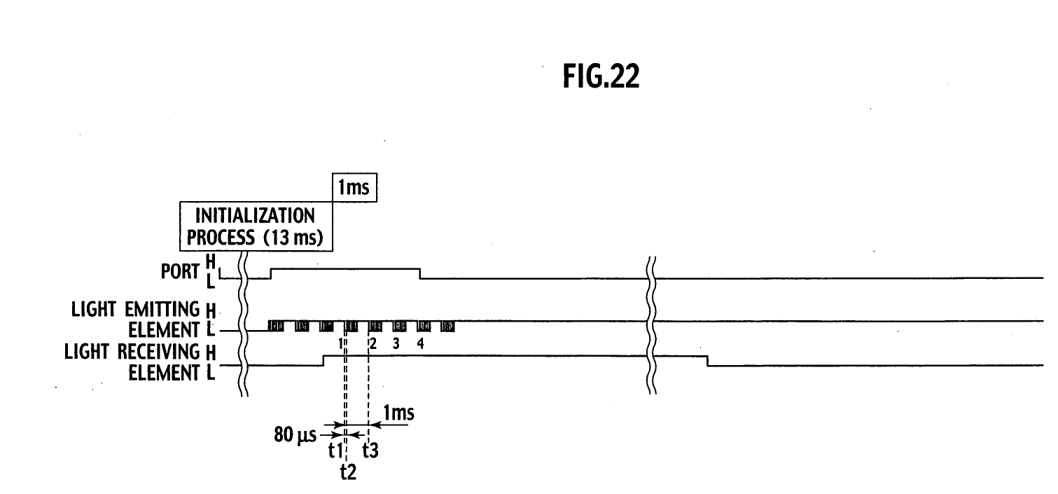

FIG. 22 is a timing chart showing the relationship the relationship between the port signal, outputted from the port 220, and the detected result of the light receiving element 131b. As shown in FIG. 22, the light emitting element 131a remains turned off for a period of approximately 80 μm (during a time interval between times t1 and t2 in FIG. 22) in operations from step S402 to step S415 and, during such a period, the current light receiving error detection process is executed. Thus, the operation is discriminated to be “NO” in step S412-2 unless an illegal light emitting unit of some kind is inserted from the outside. In such a case, since no probabilities occur wherein the value of the error counter exceeds a predetermined number (of, here, 4), the operation is discriminated to be “NO” in step S413 and the main CPU 71 discriminates that the detected result of the light receiving element 131b is normal.

On the contrary, if the illegal light emitting unit of some kind is inserted from the outside during a period between times to and t2 shown in FIG. 22, the result of step 412-2 is discriminated to be “YES”. In such a case, the value of the error counter is incremented by 1 in step S412-3 for each period intervention process shown in FIG. 17. In this moment, if the value of the error counter exceeds a value of 4, the result of step S413 is discriminated to be “YES” and the main CPU 71 discriminates that the detected result of the light receiving element 131b is not normal (in a light receiving error). Also, upon operation of the main CPU 71 to discriminate that there is the light receiving error, the operation of the slot machine 1 is stopped. In such a case, the slot machine 1 is powered on and the main CPU 71 releases the halt of the slot machine 1.

In step S412-3, the coin supervisory control CPU 210 increments the value of the error counter by 1.

In step S412-4, the coin supervisory control CPU 210 updates the value of the light receiving error timer.

In step S412-5, the coin supervisory control CPU 210 verifies whether or not the value of the light receiving error timer lies in a value of 0. Further, if the value of the light receiving error timer lies in the value of 0, the coin supervisory control CPU 210 executes the operation in step S412-6 and if the value of the light receiving error timer does not lie in the value of 0, the coin supervisory control CPU 210 executes the operation in step S412-2.

In step S412-6, the coin supervisory control CPU 210 resets the error counter to “0”.

Also, the light emitting element 131a may comprises a light emitting unit that emits a light modulated optical oscillation thereof and which has a light emitting pattern including transmission data, and the light receiving element 131b may comprises a light receiving unit synchronized with the light emitting of the light emitting unit. The coin supervisory control CPU 210 may have a structure that includes a counter, executing for instance step S410-3 and step S410-5 shown in FIG. 19, which is adapted to count the number of times indicative of whether or not there is a coincidence (in a success in demodulation) between receive data, contained in the light emitting pattern received from the light receiving element 131b and transmission data, involved in the light emitting pattern emitted from the light emitting element 131a at a timing synchronized with the light emitting pattern of receive data, for each light emitting pattern (such as a light emitting pattern present in a period from time t1 to time t3 shown in FIG. 20) emitted by the light emitting element 131a. Additionally, the coin supervisory control CPU 210 may includes a coin detecting function which detects coins passing across the coin passing portion 115 under situations where the number of coincidences reaches a first reference number (such as an upper limit value of a coincidence counter) (at, for instance, time t4 in FIG. 20 and in steps S410-7 and S410-9 in FIG. 19) and thereafter the number of non-coincidences reaches a second reference number (such as the upper limit value of the coincidence counter) (at, for instance, time t8 in FIG. 20 and in steps S410-10 and S410-12 in FIG. 19). In such a case, the presence of the coins passing across the coin passing portion 115 is detected when the number of coincidences or non-coincidences between transmission data and receive data, set forth above, exceed a given number, whereby the slot machine 1 and the coin feeding portion 100 are enabled not to erroneously recognize the coin passing in the presence of noise signals (such as, for instance, radio waves from cell phones, mobile devices, etc) entering from the outside.

Also, the light emitting element 131a may comprises a light emitting unit adapted to interrupt the emitting of light at a predetermined timing to enable the coin supervisory control CPU 210 to discriminate that when a detected result (a light receiving state of the light receiving elements 131b) varies in the absence of the light emitted from the light emitting unit, the detected result falls in an erroneous state. Further, as another alternative configuration, the light emitting element 131a may comprises a light emitting unit adapted to interrupt the emitting of light at a predetermined timing and the coin supervisory control CPU 210 may includes a counter, executing for instance step S413 shown in FIG. 17, which is adapted to count the number of times in which the detected result of the light receiving element 131b varies for each predetermined timing under circumstances where no light is emitted from the light emitting element 131a (such as, for instance, during a time period from time t1 to time t2). Furthermore, the coin supervisory control CPU 210 may be configured in a structure wherein when the number of counted times reaches a reference number (such as, for instance, an upper limit value of the light receiving error counter), the coin supervisory control CPU 210 discriminates that there is an erroneous state. In such a case, under circumstances where on condition of the absence of light emitted from the light emitting element 131a, if an illegal-light emitting element is inserted from the outside, the slot machine 1 and the coin feeding portion 100 are enabled to detect the variation in detected result of the light receiving element 131b for thereby detecting the presence of the illegal-light emitting element illegally inserted from the outside.

Also, while the coins are exemplified as gaming medium, the gaming medium may include gaming balls, coins and tokens. Further, while the slot machine is exemplified as the gaming machine, the gaming machine may includes any gaming machine which can be adapted to the structure of the present invention.

Moreover, although the examples of the reflection mode photo sensors (such as the light emitting element 131a and the light receiving element 131b) have been shown as sensors to detect the position of gaming medium, the sensors may be of reflective type sensors provided that these sensors are able to detect the position of gaming medium or the sensors may of be of the types that does not utilize the light signal but use media such as pressure waves, like sounds, and magnetic forces.

In addition, the detection sensor may include a signal transmission means (such as the light emitting element 131a) that transmits a predetermined signal, a signal receiving means (such as the light receiving element 131b) that receives transmitted signal transmitted from the transmission device and a transmission information generating means (for executing, for instance, the RESET intervention process and steps S302 and S303 shown in FIG. 15) that generates information (for instance, transmission data) to be contained in transmitted signal transmitted from the signal transmission device, and a passing discrimination means (for executing, for instance, the period intervention process) that discriminates whether or not the coins are passing across the coin passing portion 115 in response to information generated by the transmission information generating device and a signal received from the signal receiving device. This enables the position of gaming medium to be more reliably grasped than the position of gaming medium grasped by a continuously incident light only in a light-up mode of the related art. Also, other advantages include a capability of eliminating adverse affects in operation to detect gaming medium, caused by natural lights from the outside, environmental ambient lights resulting from variation in light intensity and diffused reflection due to dusts, and artificial lights for thereby precluding erroneous and malicious activities for inserting illegal gaming medium whereby it becomes possible to provide a gaming machine with a high reliability for players and associated game shops who utilize the gaming machines in which the present technologies are adopted.

Further, the coin supervisory control CPU 210 may includes a random number generating means adapted to activate in, for instance, steps S302 and S303 in RESET intervention process shown in FIG. 15, to generate the random number data (such as, for instance, transmission data) and a particular bit string (such as, for instance, transmission data), selected from a plurality of bit strings (such as, for instance, from 1 (000 0001B in a binary decimal form) to 126 (111 1110B in the binary decimal form), as information to allow the signal transmission means to convert the particular bit string to the pulse signal (such as, for instance, D1 to D7 in FIG. 18) for transmission. In addition, in cases where the particular bit string is involved in the bit strings obtained upon converting the pulse signal (such as, for instance, D1 to D7 in FIG. 18) received from the signal receiving means, the passing discrimination means may discriminate that the coins have passed across the coin passing portion 115 (with “YES” in the discriminated result in step S410-2). This enables the coin passing to be discriminated based on transmitted information, which is internally provided, providing a capability of eliminating environmental and artificial adverse affects in the same manner as set forth above.

Furthermore, the transmission information generating means may be configured to generate information based on random number data, generated by the random number generating means, for each signal transmitted by the signal transmission means (for instance, in the period intervention process, shown in FIG. 17, occurring at a fixed period) and the passing discriminating means may be configured to allow discrimination to be made that the coins have passed across the coin passing portion 115 when no particular bit string is not included in the bit strings as a result of conversion of the pulse signals consecutively received for predetermined number of times (such as, for instance, upon counting by the coincidence counter). This allows the main CPU 71 or the coin detection sensor 200 to discriminate that the coins have passed depending on whether or not the particular bit string is included in the bit strings obtained upon converting the received pulses. Thus, it becomes possible to enable the prevention of erroneous operations due to noises such as the ambient lights set forth above, enabling further improvement in reliability of the gaming machine.

While the presently filed embodiment has been described in conjunction with the occurrence of the predetermined number of consecutive times, the present invention is not limited to such a particular concept and the passing discriminating means may be configured to discriminate whether or not the coins are passing across the coin passing portion depending on whether or not the particular bit string is contained in the bit strings obtained upon converting the pulse signals received for the predetermined number of times for a predetermined time period. For instance, the main CPU 71 or the coin detection sensor 200 may be configured to discriminate whether or not the coins are passing depending whether the particular bit string is contained in the bit strings obtained upon converting the pulse signals received for more than four times for discrimination timings of consecutive five times.

According to the present invention, it becomes possible to prevent the payout of the coins in excess due to illegal activities.

Also, while the presently filed embodiment has been described above in more detail, it is apparent to those skilled in the art that the present invention is not limited to the embodiment described in the present application. The device of the present invention can be embodied in modified or alternative forms without departing from the spirits and scopes of the present invention as set out in the appended claims. Accordingly, the description of the present invention is meant to be illustrative only and not limiting to the scope of present invention.

1. A coin feeding machine comprising:
a coin receiving portion receiving coins;
a coin passing portion formed to allow the coins to pass;
a coin feeding portion that feeds the coins, received in the coin receiving portion, to the coin passing portion one by one; and
a coin detecting sensor detecting the coins passing across the coin passing portion,
wherein the coin detecting sensor further includes a light emitting element and a light receiving element, and the light emitting element emits a light upon modulation of an optical oscillation,
and wherein the coin detecting portion determines that the coins do not pass across the coin passing portion when the light receiving element is synchronized with the light emitted from the light emitting element and able to demodulate the light emitted from the light emitting element, and the coin detecting portion determines that that the coins pass across the coin passing portion when the light emitted from the light emitting element can not be demodulated by the light receiving element.

2. The coin feeding machine according to claim 1, further comprising
an error detecting unit operative to detect that a payout of the coins is in error in a case where the light emitted from the light emitting element is not synchronized with the light accepted by the light receiving element.

3. The coin feeding machine according to claim 2, wherein
the coin feeding portion precludes the coins from fed to the coin passing portion when the error detecting unit detects that the payout of the coins is in error.

4. The coin feeding machine according to claim 2, further comprising
a notifying unit providing a notification when the error detecting unit detects that the payout of the coins is in error.

5. The coin feeding machine according to claim 1, wherein
the light emitting element is adapted to emit a light including a specified bit string that is arbitrarily generated, and the light receiving element is adapted to detect the specified bit string,
and wherein the coin detecting portion determines that the coins pass across the coin passing portion when the specified bit string is detected by the light receiving element.

6. The coin feeding machine according to claim 5, wherein
the coin detecting portion determines that the coins pass across the coin passing portion when the light receiving element detects the specified bit string included in the light consecutively emitted from the light emitting element for a predetermined number of times and thereafter the light receiving element does not detect the specified bit string included in the light consecutively emitted from the light emitting element for the predetermined number of times.

7. A gaming machine comprising:
a coin receiving portion receiving coins;
a coin passing portion formed to allow the coins to pass;
a coin feeding portion that feeds coins, received in the receiving portion, to the coin passing portion one by one; and
a coin detecting sensor detecting the coins passing across the coin passing portion,
wherein the coin detecting sensor further includes a light emitting element and a light receiving element, and the light emitting element emits a light upon modulation of an optical oscillation,
and wherein the coin detecting portion determines that the coins do not pass across the coin passing portion when the light receiving element is synchronized with the light emitted from the light emitting element and able to demodulate the light emitted from the light emitting element, and the coin detecting portion determines that the coins pass across the coin passing portion when the light emitted from the light emitting element can not be demodulated by the light receiving element.
